(19) United States
(12) Patent Application Publication
(10) Pub. No.: US 2008/0111834 A1
(43) Pub. Date: May 15, 2008

(54) Two primary color display

(76) Inventor: Marc M. Mignard, San Jose, CA (US)

Correspondence Address: KNOBBE, MARTENS, OLSON & BEAR, LLP, 2040 MAIN STREET, FOURTEENTH FLOOR, IRVINE, CA, 92614, US

(21) Appl. No.: 11/595,621

(22) Filed: Nov. 9, 2006

(51) Int. Cl. G09G 5/10

(52) U.S. Cl. 345/690

(57) ABSTRACT

A color display comprising a plurality of pixels is disclosed, wherein each pixel comprises two or fewer subpixels. In one embodiment, a color display comprises a fixed color display element configured to provide light of a first color, and a variable color display element configured to provide light of a variable second color, wherein the second color is variably controlled such that the variable color and fixed color display elements collectively and operatively display light of a perceivable color.

### BACKGROUND OF THE INVENTION

1. Field of the Invention

The field of the invention relates to microelectromechanical systems (MEMS).

2. Description of the Related Technology

Microelectromechanical systems (MEMS) include micro mechanical elements, actuators, and electronics. Micromechanical elements may be created using deposition, etching, and/or other micromachining processes that etch away parts of substrates and/or deposited material layers or that add layers to form electrical and electromechanical devices. One type of MEMS device is called an interferometric modulator. As used herein, the term interferometric modulator or interferometric light modulator refers to a device that selectively absorbs and/or reflects light using the principles of optical interference. In certain embodiments, an interferometric modulator may comprise a pair of conductive plates, one or both of which may be transparent and/or reflective in whole or part and capable of relative motion upon application of an appropriate electrical signal. In a particular embodiment, one plate may comprise a stationary layer deposited on a substrate and the other plate may comprise a metallic membrane separated from the stationary layer by an air gap. As described herein in more detail, the position of one plate in relation to another can change the optical interference of light incident on the interferometric modulator. Such devices have a wide range of applications, and it would be beneficial in the art to utilize and/or modify the characteristics of these types of devices so that their features can be exploited in improving existing products and creating new products that have not yet been developed.

### SUMMARY OF CERTAIN EMBODIMENTS

In one embodiment, a color display comprises a fixed color display element configured to provide light of a first color, and a variable color display element configured to provide light of a variable second color, wherein the second color is variably controlled such that the variable color and fixed color display elements collectively and operatively display light of a perceivable color.

In another embodiment, a color display comprises a first variable color display element configured to provide light of a variable first color, and a second variable color display element configured to provide light of a variable second color, wherein the first and second colors are variably controlled such that the first and second variable color display elements collectively and operatively display light of a perceivable color.

In another embodiment, a color display comprises a variable color display element configured to provide light of a variable color, wherein the variable color display element is controlled to provide light of a first color for a first period and then light of a second color for a second period such that the display element provides light of a perceivable color.

In another embodiment, a color display comprises a plurality of pixels, each pixel comprising two or fewer subpixels, wherein each pixel is capable of displaying a group of colors comprising a substantially red color, a substantially green color, and a substantially blue color.

In another embodiment, a method of displaying a perceivable color comprises providing a display comprising a fixed color display element configured to provide light of a first color and a variable color display element configured to provide light of a variable color, and controlling the variable color display element to provide light of a selected second color such that the first color and second color collectively provide light of the perceivable color.

In another embodiment, a method of displaying a perceivable color comprises providing a display comprising a first and second variable color display element, each element being configured to provide light of a variable color, and controlling the first and second variable color display element to provide light of a selected first and second color respectively such that the first color and second color collectively provide light of the perceivable color.

In another embodiment, a method of displaying a perceivable color comprises providing a display comprising a variable color display element configured to provide light of a variable color, and controlling the variable color display element to provide light of a selected first color for a first period and provide light of a selected second color for a second period such that the display element provides light of a perceivable color.

In another embodiment, a color display comprises means for providing light of a first color and means for providing light of a variable second color, wherein the second color is variably controlled such that the means for providing light of a first color and the means for providing light of a second color collectively and operatively display light of a perceivable color.

In another embodiment, a color display comprises means for providing light of a variable first color, and means for providing light of a variable second color, wherein the first and second colors are variably controlled such that the means for providing light of a variable first color and the means for providing light of a variable second color collectively and operatively display light of a perceivable color.

In another embodiment, a color display comprises means for providing light of a variable color and means for processing image data, the means being configured to communicate with the means for providing, wherein the means for providing is controlled to provide light of a first color for a first period and then light of a second color for a second period such that the means for providing provides light of a perceivable color.

### BRIEF DESCRIPTION OF THE DRAWINGS

FIG. 1 is an isometric view depicting a portion of one embodiment of an interferometric modulator display in which a movable reflective layer of a first interferometric modulator is in a relaxed position and a movable reflective layer of a second interferometric modulator is in an actuated position.

FIG. 2 is a system block diagram illustrating one embodiment of an electronic device incorporating a 3×3 interferometric modulator display.

FIG. 3 is a diagram of movable mirror position versus applied voltage for one exemplary embodiment of an interferometric modulator of FIG. 1.

FIG. 4 is an illustration of a set of row and column voltages that may be used to drive an interferometric modulator display.

FIG. 5A illustrates one exemplary frame of display data in the 3×3 interferometric modulator display of FIG. 2.

FIG. 5B illustrates one exemplary timing diagram for row and column signals that may be used to write the frame of FIG. 5A.

FIGS. 6A and 6B are system block diagrams illustrating an embodiment of a visual display device comprising a plurality of interferometric modulators.

FIG. 7A is a cross section of the device of FIG. 1.

FIG. 7B is a cross section of an alternative embodiment of an interferometric modulator.

FIG. 7C is a cross section of another alternative embodiment of an interferometric modulator.

FIG. 7D is a cross section of yet another alternative embodiment of an interferometric modulator.

FIG. 7E is a cross section of an additional alternative embodiment of an interferometric modulator.

FIG. 8 illustrates one embodiment of a color display 100 wherein each pixel comprises two or less subpixels.

FIG. 9 shows a CIE color space plot illustrating the possible set of colors that can be generated by one embodiment of an interferometric modulator display element as illustrated in FIG. 1.

FIG. 10 shows a CIE color space plot with the color gamut of one embodiment of a color display 100 as illustrated in FIG. 8.

FIG. 11 is a flowchart illustrating one embodiment of a method of displaying a desired perceivable color in a display 100 as illustrated in FIG. 8.

FIG. 12 shows a CIE color space plot with the possible set of colors that can be generated by another embodiment of a color display wherein each pixel comprises two or less subpixels.

FIG. 13 is a flowchart illustrating one embodiment of a method of displaying a desired perceivable color in a display as discussed above with regard to FIG. 12.

FIG. 14 illustrates another embodiment of a color display wherein each pixel comprises two or less subpixels.

FIG. 15 is a flowchart illustrating one embodiment of a method of displaying a desired perceivable color in a display as illustrated in FIG. 14.

FIGS. 16A, 16B illustrate an embodiment of a MEMS device in a side cross-sectional view.

FIGS. 16C, 16D illustrate another embodiment of a MEMS device in a side cross-sectional view.

FIG. 17 illustrates the relationship between the movement of the mirror surface of an interferometric modulator and the electric potential difference between the optical layer and the mirror surface of the interferometric modulator.

FIGS. 18A, 18B illustrate another embodiment of a MEMS device in a side cross-sectional view.

FIG. 19 illustrates exemplary voltage differences applied among the three electrodes to create a highly tunable MEMS device.

### DETAILED DESCRIPTION OF THE CERTAIN EMBODIMENTS OF THE INVENTION

The following detailed description is directed to certain specific embodiments of the invention. However, the invention can be embodied in a multitude of different ways. In this description, reference is made to the drawings wherein like parts are designated with like numerals throughout. As will be apparent from the following description, the embodiments may be implemented in any device that is configured to display an image, whether in motion (e.g., video) or stationary (e.g., still image), and whether textual or pictorial. More particularly, it is contemplated that the embodiments may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures, packaging, and aesthetic structures (e.g., display of images on a piece of jewelry). MEMS devices of similar structure to those described herein can also be used in non-display applications such as in electronic switching devices.

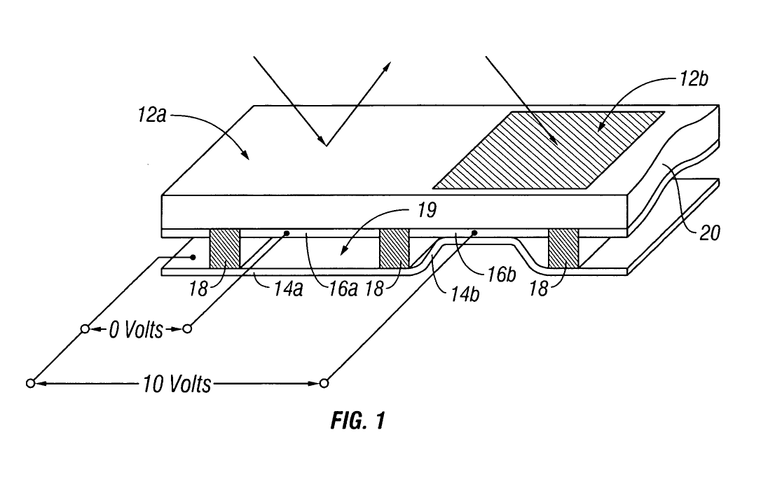

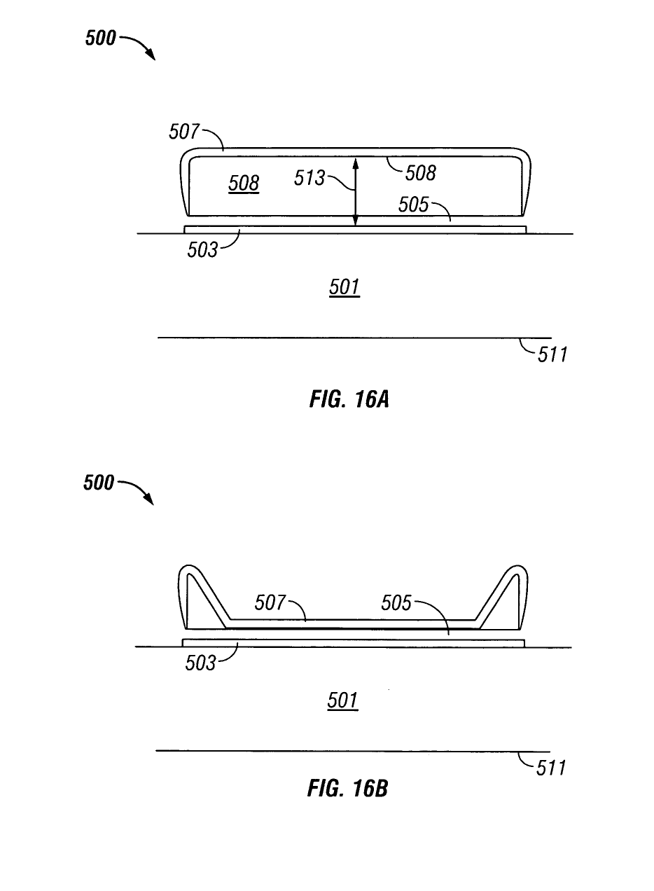

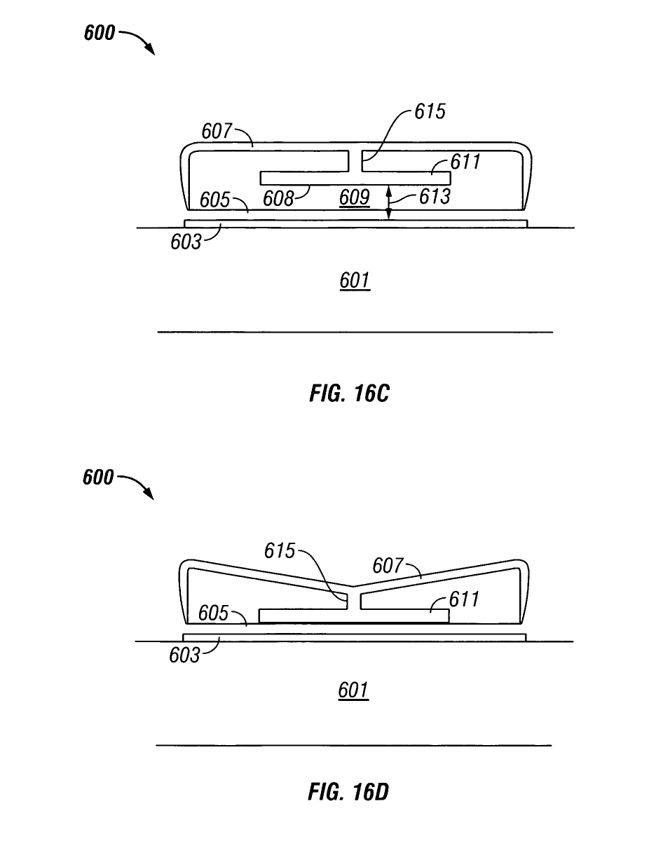

Certain embodiments provide a color display in which each pixel comprises only two or less subpixels while being capable of producing any color within its color gamut. Two different types of interferometric MEMS display elements, i.e., a fixed color display element and a variable color display element, are used in these embodiments. The fixed color display element is configured to either reflect light of a fixed wavelength or appears black. The analog color display element is configured to reflect light of a variable wavelength or appears black. FIGS. 1-7E show the fixed color display element and FIGS. 16A-19 illustrate the variable color display element.

One interferometric modulator display embodiment comprising an interferometric MEMS display element is illustrated in FIG. 1. In these devices, the pixels are in either a bright or dark state. In the bright (“on” or “open”) state, the display element reflects a large portion of incident visible light to a user. When in the dark (“off” or “closed”) state, the display element reflects little incident visible light to the user. Depending on the embodiment, the light reflectance properties of the “on” and “off” states may be reversed. MEMS pixels can be configured to reflect predominantly at selected colors, allowing for a color display in addition to black and white.

FIG. 1 is an isometric view depicting two adjacent pixels in a series of pixels of a visual display, wherein each pixel comprises a MEMS interferometric modulator. In some embodiments, an interferometric modulator display comprises a row/column array of these interferometric modulators. Each interferometric modulator includes a pair of reflective layers positioned at a variable and controllable distance from each other to form a resonant optical cavity with at least one variable dimension. In one embodiment, one of the reflective layers may be moved between two positions. In the first position, referred to herein as the relaxed position, the movable reflective layer is positioned at a relatively large distance from a fixed partially reflective layer. In the second position, referred to herein as the actuated position, the movable reflective layer is positioned more closely adjacent to the partially reflective layer. Incident light that reflects from the two layers interferes constructively or destructively depending on the position of the movable reflective layer, producing either an overall reflective or non-reflective state for each pixel.

The depicted portion of the pixel array in FIG. 1 includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

The optical stacks 16a and 16b (collectively referred to as optical stack 16), as referenced herein, typically comprise several fused layers, which can include an electrode layer, such as indium tin oxide (ITO), a partially reflective layer, such as chromium, and a transparent dielectric. The optical stack 16 is thus electrically conductive, partially transparent, and partially reflective, and may be fabricated, for example, by depositing one or more of the above layers onto a transparent substrate 20. The partially reflective layer can be formed from a variety of materials that are partially reflective such as various metals, semiconductors, and dielectrics. The partially reflective layer can be formed of one or more layers of materials, and each of the layers can be formed of a single material or a combination of materials.

In some embodiments, the layers of the optical stack 16 are patterned into parallel strips, and may form row electrodes in a display device as described further below. The movable reflective layers 14a, 14b may be formed as a series of parallel strips of a deposited metal layer or layers (orthogonal to the row electrodes of 16a, 16b) deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form column electrodes in a display device.

With no applied voltage, the cavity 19 remains between the movable reflective layer 14a and optical stack 16a, with the movable reflective layer 14a in a mechanically relaxed state, as illustrated by the pixel 12a in FIG. 1. However, when a potential difference is applied to a selected row and column, the capacitor formed at the intersection of the row and column electrodes at the corresponding pixel becomes charged, and electrostatic forces pull the electrodes together. If the voltage is high enough, the movable reflective layer 14 is deformed and is forced against the optical stack 16. A dielectric layer (not illustrated in this Figure) within the optical stack 16 may prevent shorting and control the separation distance between layers 14 and 16, as illustrated by pixel 12b on the right in FIG. 1. The behavior is the same regardless of the polarity of the applied potential difference. In this way, row/column actuation that can control the reflective vs. non-reflective pixel states is analogous in many ways to that used in conventional LCD and other display technologies.

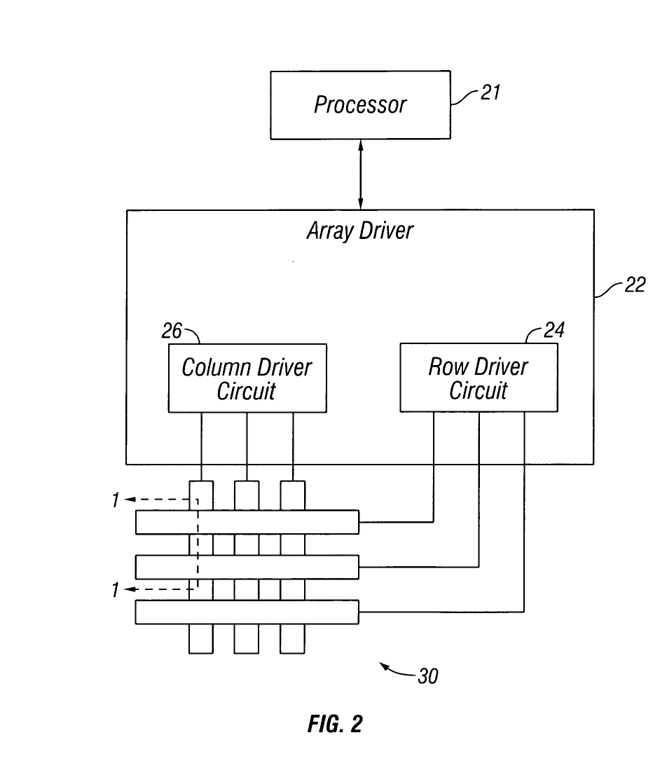

FIGS. 2 through 5B illustrate one exemplary process and system for using an array of interferometric modulators in a display application.

FIG. 2 is a system block diagram illustrating one embodiment of an electronic device that may incorporate aspects of the invention. In the exemplary embodiment, the electronic device includes a processor 21 which may be any general purpose single- or multi-chip microprocessor such as an ARM, Pentium®, Pentium II®, Pentium III®, Pentium IV®, Pentium® Pro, an 8051, a MIPS®, a Power PC®, an ALPHA®, or any special purpose microprocessor such as a digital signal processor, microcontroller, or a programmable gate array. As is conventional in the art, the processor 21 may be configured to execute one or more software modules. In addition to executing an operating system, the processor may be configured to execute one or more software applications, including a web browser, a telephone application, an email program, or any other software application.

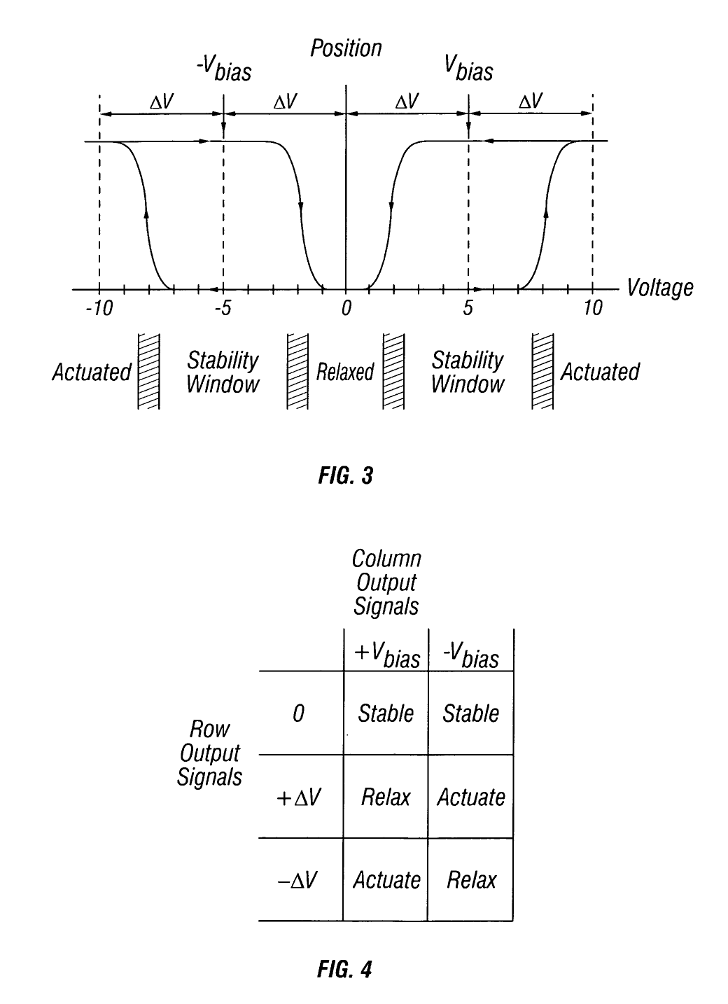

In one embodiment, the processor 21 is also configured to communicate with an array driver 22. In one embodiment, the array driver 22 includes a row driver circuit 24 and a column driver circuit 26 that provide signals to a display array or panel 30. The cross section of the array illustrated in FIG. 1 is shown by the lines 1-1 in FIG. 2. For MEMS interferometric modulators, the row/column actuation protocol may take advantage of a hysteresis property of these devices illustrated in FIG. 3. It may require, for example, a 10 volt potential difference to cause a movable layer to deform from the relaxed state to the actuated state. However, when the voltage is reduced from that value, the movable layer maintains its state as the voltage drops back below 10 volts. In the exemplary embodiment of FIG. 3, the movable layer does not relax completely until the voltage drops below 2 volts. Thus, there exists a window of applied voltage, about 3 to 7 V in the example illustrated in FIG. 3, within which the device is stable in either the relaxed or actuated state. This is referred to herein as the “hysteresis window” or “stability window.” For a display array having the hysteresis characteristics of FIG. 3, the row/column actuation protocol can be designed such that during row strobing, pixels in the strobed row that are to be actuated are exposed to a voltage difference of about 10 volts, and pixels that are to be relaxed are exposed to a voltage difference of close to zero volts. After the strobe, the pixels are exposed to a steady state voltage difference of about 5 volts such that they remain in whatever state the row strobe put them in. After being written, each pixel sees a potential difference within the “stability window” of 3-7 volts in this example. This feature makes the pixel design illustrated in FIG. 1 stable under the same applied voltage conditions in either an actuated or relaxed pre-existing state. Since each pixel of the interferometric modulator, whether in the actuated or relaxed state, is essentially a capacitor formed by the fixed and moving reflective layers, this stable state can be held at a voltage within the hysteresis window with almost no power dissipation. Essentially no current flows into the pixel if the applied potential is fixed.

In typical applications, a display frame may be created by asserting the set of column electrodes in accordance with the desired set of actuated pixels in the first row. A row pulse is then applied to the row 1 electrode, actuating the pixels corresponding to the asserted column lines. The asserted set of column electrodes is then changed to correspond to the desired set of actuated pixels in the second row. A pulse is then applied to the row 2 electrode, actuating the appropriate pixels in row 2 in accordance with the asserted column electrodes. The row 1 pixels are unaffected by the row 2 pulse, and remain in the state they were set to during the row 1 pulse. This may be repeated for the entire series of rows in a sequential fashion to produce the frame. Generally, the frames are refreshed and/or updated with new display data by continually repeating this process at some desired number of frames per second. A wide variety of protocols for driving row and column electrodes of pixel arrays to produce display frames are also well known and may be used in conjunction with the present invention.

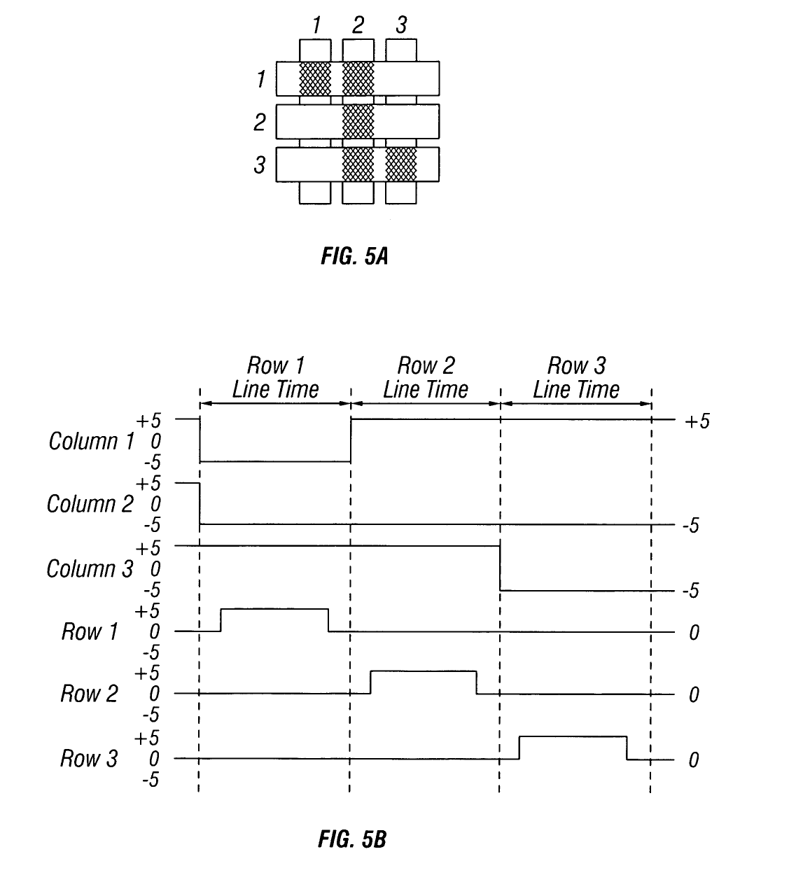

FIGS. 4, 5A, and 5B illustrate one possible actuation protocol for creating a display frame on the 3×3 array of FIG. 2. FIG. 4 illustrates a possible set of column and row voltage levels that may be used for pixels exhibiting the hysteresis curves of FIG. 3. In the FIG. 4 embodiment, actuating a pixel involves setting the appropriate column to −V_{bias}, and the appropriate row to +ΔV, which may correspond to −5 volts and +5 volts, respectively Relaxing the pixel is accomplished by setting the appropriate column to +V_{bias}, and the appropriate row to the same +ΔV, producing a zero volt potential difference across the pixel. In those rows where the row voltage is held at zero volts, the pixels are stable in whatever state they were originally in, regardless of whether the column is at +V_{bias}, or −V_{bias}. As is also illustrated in FIG. 4, it will be appreciated that voltages of opposite polarity than those described above can be used, e.g., actuating a pixel can involve setting the appropriate column to +V_{bias}, and the appropriate row to −ΔV. In this embodiment, releasing the pixel is accomplished by setting the appropriate column to −V_{bias}, and the appropriate row to the same −ΔV, producing a zero volt potential difference across the pixel.

FIG. 5B is a timing diagram showing a series of row and column signals applied to the 3×3 array of FIG. 2 which will result in the display arrangement illustrated in FIG. 5A, where actuated pixels are non-reflective. Prior to writing the frame illustrated in FIG. 5A, the pixels can be in any state, and in this example, all the rows are at 0 volts, and all the columns are at +5 volts. With these applied voltages, all pixels are stable in their existing actuated or relaxed states.

In the FIG. 5A frame, pixels (1,1), (1,2), (2,2), (3,2) and (3,3) are actuated. To accomplish this, during a “line time” for row 1, columns 1 and 2 are set to −5 volts, and column 3 is set to +5 volts. This does not change the state of any pixels, because all the pixels remain in the 3-7 volt stability window. Row 1 is then strobed with a pulse that goes from 0, up to 5 volts, and back to zero. This actuates the (1,1) and (1,2) pixels and relaxes the (1,3) pixel. No other pixels in the array are affected. To set row 2 as desired, column 2 is set to −5 volts, and columns 1 and 3 are set to +5 volts. The same strobe applied to row 2 will then actuate pixel (2,2) and relax pixels (2,1) and (2,3). Again, no other pixels of the array are affected. Row 3 is similarly set by setting columns 2 and 3 to −5 volts, and column 1 to +5 volts. The row 3 strobe sets the row 3 pixels as shown in FIG. 5A. After writing the frame, the row potentials are zero, and the column potentials can remain at either +5 or −5 volts, and the display is then stable in the arrangement of FIG. 5A. It will be appreciated that the same procedure can be employed for arrays of dozens or hundreds of rows and columns. It will also be appreciated that the timing, sequence, and levels of voltages used to perform row and column actuation can be varied widely within the general principles outlined above, and the above example is exemplary only, and any actuation voltage method can be used with the systems and methods described herein.

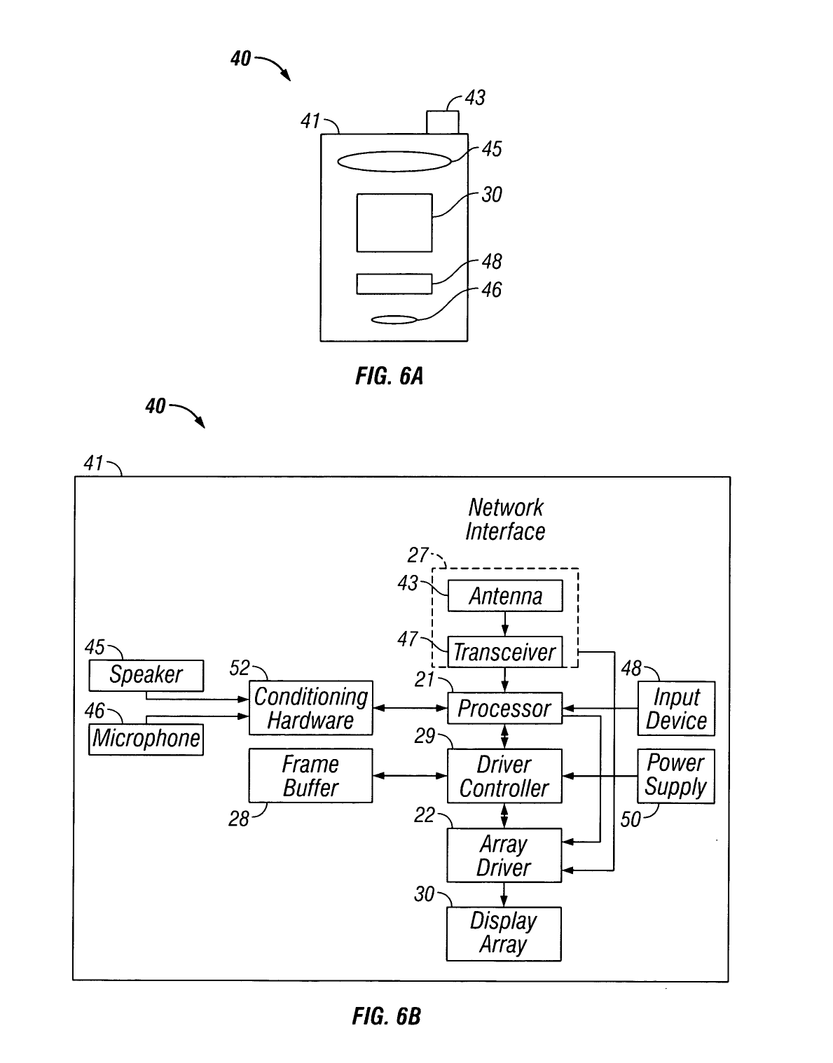

FIGS. 6A and 6B are system block diagrams illustrating an embodiment of a display device 40. The display device 40 can be, for example, a cellular or mobile telephone. However, the same components of display device 40 or slight variations thereof are also illustrative of various types of display devices such as televisions and portable media players.

The display device 40 includes a housing 41, a display 30, an antenna 43, a speaker 44, an input device 48, and a microphone 46. The housing 41 is generally formed from any of a variety of manufacturing processes as are well known to those of skill in the art, including injection molding and vacuum forming. In addition, the housing 41 may be made from any of a variety of materials, including, but not limited to, plastic, metal, glass, rubber, and ceramic, or a combination thereof. In one embodiment, the housing 41 includes removable portions (not shown) that may be interchanged with other removable portions of different color, or containing different logos, pictures, or symbols.

The display 30 of exemplary display device 40 may be any of a variety of displays, including a bi-stable display, as described herein. In other embodiments, the display 30 includes a flat-panel display, such as plasma, EL, OLED, STN LCD, or TFT LCD as described above, or a non-flat-panel display, such as a CRT or other tube device, as is well known to those of skill in the art. However, for purposes of describing the present embodiment, the display 30 includes an interferometric modulator display, as described herein.

The components of one embodiment of exemplary display device 40 are schematically illustrated in FIG. 6B. The illustrated exemplary display device 40 includes a housing 41 and can include additional components at least partially enclosed therein. For example, in one embodiment, the exemplary display device 40 includes a network interface 27 that includes an antenna 43, which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28 and to an array driver 22, which in turn is coupled to a display array 30. A power supply 50 provides power to all components as required by the particular exemplary display device 40 design.

The network interface 27 includes the antenna 43 and the transceiver 47 so that the exemplary display device 40 can communicate with one or more devices over a network. In one embodiment, the network interface 27 may also have some processing capabilities to relieve requirements of the processor 21. The antenna 43 is any antenna known to those of skill in the art for transmitting and receiving signals. In one embodiment, the antenna transmits and receives RF signals according to the IEEE 802.11 standard, including IEEE 802.11(a), (b), or (g). In another embodiment, the antenna transmits and receives RF signals according to the BLUETOOTH standard. In the case of a cellular telephone, the antenna is designed to receive CDMA, GSM, AMPS, or other known signals that are used to communicate within a wireless cell phone network. The transceiver 47 pre-processes the signals received from the antenna 43 so that they may be received by and further manipulated by the processor 21. The transceiver 47 also processes signals received from the processor 21 so that they may be transmitted from the exemplary display device 40 via the antenna 43.

In an alternative embodiment, the transceiver 47 can be replaced by a receiver. In yet another alternative embodiment, network interface 27 can be replaced by an image source, which can store or generate image data to be sent to the processor 21. For example, the image source can be a digital video disc (DVD) or a hard-disc drive that contains image data, or a software module that generates image data.

Processor 21 generally controls the overall operation of the exemplary display device 40. The processor 21 receives data, such as compressed image data from the network interface 27 or an image source, and processes the data into raw image data or into a format that is readily processed into raw image data. The processor 21 then sends the processed data to the driver controller 29 or to frame buffer 28 for storage. Raw data typically refers to the information that identifies the image characteristics at each location within an image. For example, such image characteristics can include color, saturation, and gray-scale level.

In one embodiment, the processor 21 includes a microcontroller, CPU, or logic unit to control operation of the exemplary display device 40. Conditioning hardware 52 generally includes amplifiers and filters for transmitting signals to the speaker 45, and for receiving signals from the microphone 46. Conditioning hardware 52 may be discrete components within the exemplary display device 40, or may be incorporated within the processor 21 or other components.

The driver controller 29 takes the raw image data generated by the processor 21 either directly from the processor 21 or from the frame buffer 28 and reformats the raw image data appropriately for high speed transmission to the array driver 22. Specifically, the driver controller 29 reformats the raw image data into a data flow having a raster-like format, such that it has a time order suitable for scanning across the display array 30. Then the driver controller 29 sends the formatted information to the array driver 22. Although a driver controller 29, such as a LCD controller, is often associated with the system processor 21 as a stand-alone Integrated Circuit (IC), such controllers may be implemented in many ways. They may be embedded in the processor 21 as hardware, embedded in the processor 21 as software, or fully integrated in hardware with the array driver 22.

Typically, the array driver 22 receives the formatted information from the driver controller 29 and reformats the video data into a parallel set of waveforms that are applied many times per second to the hundreds and sometimes thousands of leads coming from the display's x-y matrix of pixels.

In one embodiment, the driver controller 29, array driver 22, and display array 30 are appropriate for any of the types of displays described herein. For example, in one embodiment, driver controller 29 is a conventional display controller or a bi-stable display controller (e.g., an interferometric modulator controller). In another embodiment, array driver 22 is a conventional driver or a bi-stable display driver (e.g., an interferometric modulator display). In one embodiment, a driver controller 29 is integrated with the array driver 22. Such an embodiment is common in highly integrated systems such as cellular phones, watches, and other small area displays. In yet another embodiment, display array 30 is a typical display array or a bi-stable display array (e.g., a display including an array of interferometric modulators).

The input device 48 allows a user to control the operation of the exemplary display device 40. In one embodiment, input device 48 includes a keypad, such as a QWERTY keyboard or a telephone keypad, a button, a switch, a touch-sensitive screen, or a pressure- or heat-sensitive membrane. In one embodiment, the microphone 46 is an input device for the exemplary display device 40. When the microphone 46 is used to input data to the device, voice commands may be provided by a user for controlling operations of the exemplary display device 40.

Power supply 50 can include a variety of energy storage devices as are well known in the art. For example, in one embodiment, power supply 50 is a rechargeable battery, such as a nickel-cadmium battery or a lithium ion battery. In another embodiment, power supply 50 is a renewable energy source, a capacitor, or a solar cell including a plastic solar cell, and solar-cell paint. In another embodiment, power supply 50 is configured to receive power from a wall outlet.

In some embodiments, control programmability resides, as described above, in a driver controller which can be located in several places in the electronic display system. In some embodiments, control programmability resides in the array driver 22. Those of skill in the art will recognize that the above-described optimizations may be implemented in any number of hardware and/or software components and in various configurations.

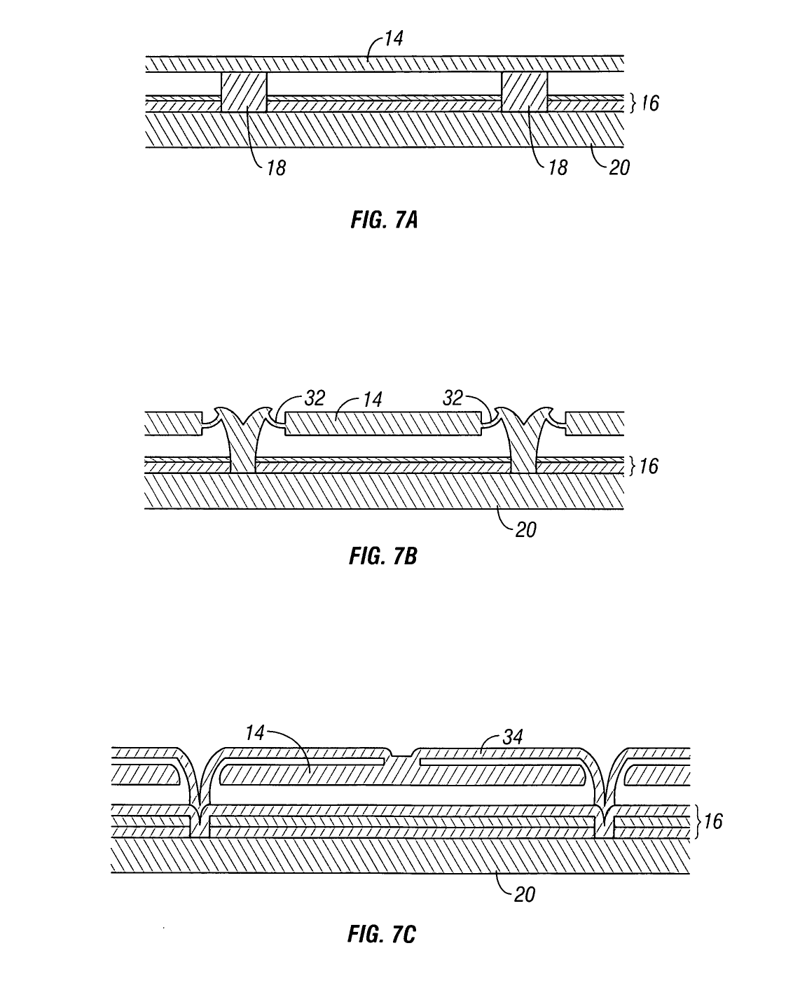

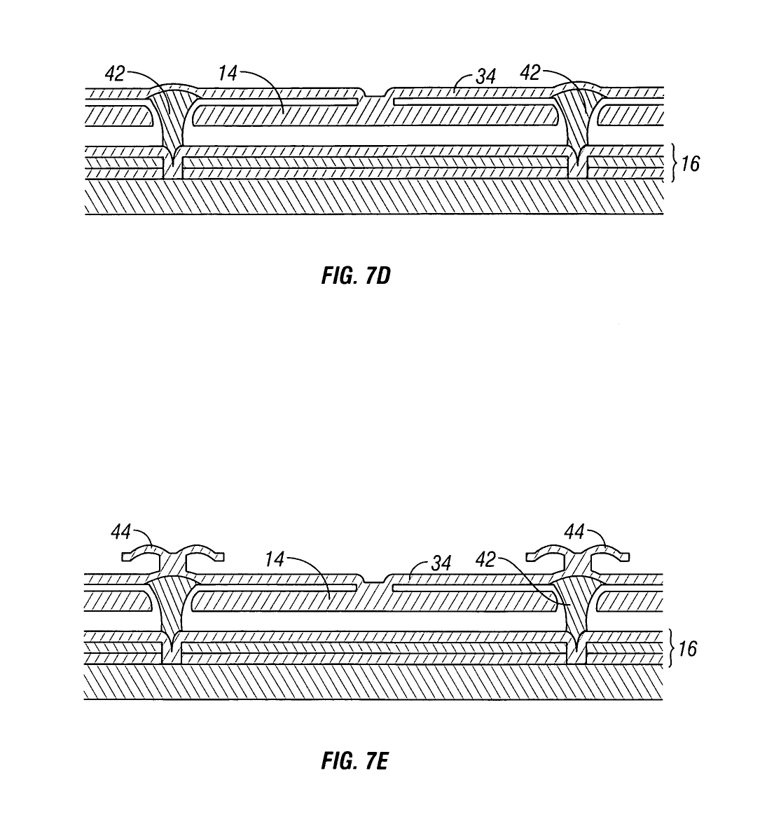

The details of the structure of interferometric modulators that operate in accordance with the principles set forth above may vary widely. For example, FIGS. 7A-7E illustrate five different embodiments of the movable reflective layer 14 and its supporting structures. FIG. 7A is a cross section of the embodiment of FIG. 1, where a strip of metal material 14 is deposited on orthogonally extending supports 18. In FIG. 7B, the moveable reflective layer 14 is attached to supports at the corners only, on tethers 32. In FIG. 7C, the moveable reflective layer 14 is suspended from a deformable layer 34, which may comprise a flexible metal. The deformable layer 34 connects, directly or indirectly, to the substrate 20 around the perimeter of the deformable layer 34. These connections are herein referred to as support posts. The embodiment illustrated in FIG. 7D has support post plugs 42 upon which the deformable layer 34 rests. The movable reflective layer 14 remains suspended over the cavity, as in FIGS. 7A-7C, but the deformable layer 34 does not form the support posts by filling holes between the deformable layer 34 and the optical stack 16. Rather, the support posts are formed of a planarization material, which is used to form support post plugs 42. The embodiment illustrated in FIG. 7E is based on the embodiment shown in FIG. 7D, but may also be adapted to work with any of the embodiments illustrated in FIGS. 7A-7C, as well as additional embodiments not shown. In the embodiment shown in FIG. 7E, an extra layer of metal or other conductive material has been used to form a bus structure 44. This allows signal routing along the back of the interferometric modulators, eliminating a number of electrodes that may otherwise have had to be formed on the substrate 20.

In embodiments such as those shown in FIG. 7, the interferometric modulators function as direct-view devices, in which images are viewed from the front side of the transparent substrate 20, the side opposite to that upon which the modulator is arranged. In these embodiments, the reflective layer 14 optically shields the portions of the interferometric modulator on the side of the reflective layer opposite the substrate 20, including the deformable layer 34. This allows the shielded areas to be configured and operated upon without negatively affecting the image quality. Such shielding allows the bus structure 44 in FIG. 7E, which provides the ability to separate the optical properties of the modulator from the electromechanical properties of the modulator, such as addressing and the movements that result from that addressing. This separable modulator architecture allows the structural design and materials used for the electromechanical aspects and the optical aspects of the modulator to be selected and to function independently of each other. Moreover, the embodiments shown in FIGS. 7C-7E have additional benefits deriving from the decoupling of the optical properties of the reflective layer 14 from its mechanical properties, which are carried out by the deformable layer 34. This allows the structural design and materials used for the reflective layer 14 to be optimized with respect to the optical properties, and the structural design and materials used for the deformable layer 34 to be optimized with respect to desired mechanical properties.

Most color display technologies such as CRT, LCD, projectors, film, and printing, use a fixed number of primary colors (usually 3) which are selectively mixed to give any color within the technologies' gamut. In the case of CRT and LCD displays, each pixel is broken into three parts, a red, green, and blue subpixel. Certain embodiments of the invention provide a color display of a color gamut at least comparable to the current LCD displays, wherein each pixel comprises only two or less subpixels while being capable of producing any color within its color gamut.

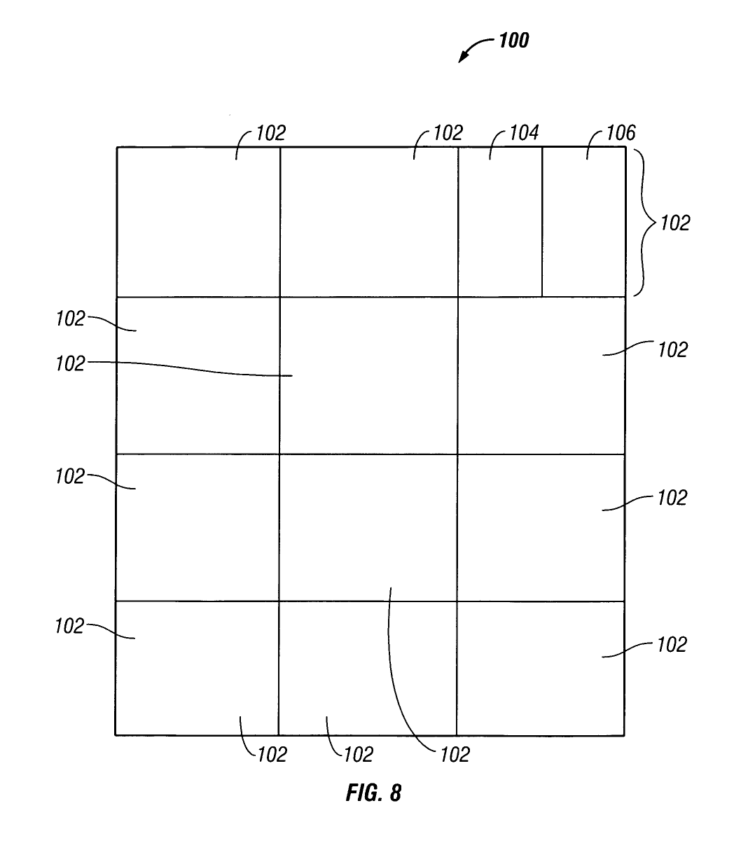

FIG. 8 illustrates one embodiment of a color display 100 wherein each pixel comprises two or less subpixels. The display 100 may be constructed by manufacturing an array of interferometric modulator structures. The structures may be grouped into an array of pixels 102. Each pixel in the display comprises two interferometric modulator structures, 104 and 106, referred to as “subpixels.” The hue generated by the pixel 102 will be determined by the color and amount of light reflected by each subpixel. The amount of light reflected by a display element such as a subpixel or pixel is often referred to as “brightness” of that display element. As used herein, “hue” refers to the color perceived by a human observer of the reflected light.

The subpixel 104 comprises an interferometric modulator display element as illustrated in FIG. 1, which will be referred as a “fixed color display element” below. As discussed above, an interferometric modulator display element is configured to either reflect light of a fixed wavelength or in a dark state. The reflective spectral characteristics of the interferometric modulator are dependent upon the gap between the reflective layers 14a and 16a.

The subpixel 106 comprises an analog interferometric modulator display element (which may also be referred to as a “variable color display element” below) that is tunable substantially throughout a range of movement of a reflective layer within an interferometric cavity. The movement of the movable layer within the interferometric cavity may be controllable by voltages applied to the display element. Depending on the interferometric cavity depth, which is the gap between the movable reflective layer and a fixed reflective layer, a certain wavelength of the light is reflective to the viewer. Any movement of the movable reflective layer may change the interferometric cavity depth and cause a different wavelength of the light to be reflected to the viewer. Since the analog display element is tunable throughout a range of linear movement of the movable reflective layer, it may be used as a reflective display element tunable to any colored visible light or tunable to any wavelength of light. In one embodiment, the analog display element may be controlled such that either a colored light corresponding to a variably selected wavelength is displayed or the display element appears black to a viewer. An exemplary analog interferometric modulator display element is described in further detail with regard to FIGS. 16-19. In certain embodiments, it may be desirable to put the reference electrode of the analog interferometric modulator display element behind the display.

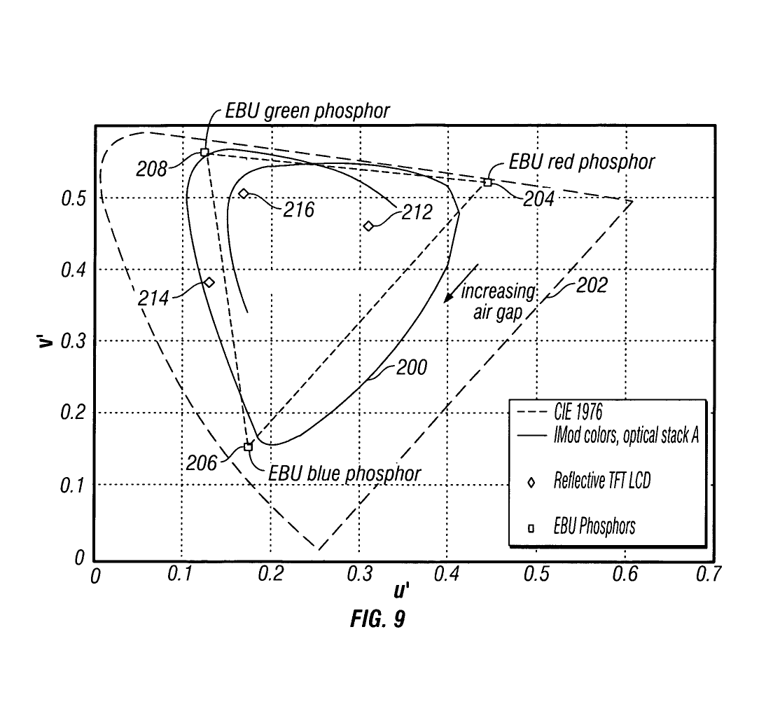

FIG. 9 shows a CIE color space plot illustrating the possible set of colors that can be generated by one embodiment of an interferometric modulator display element as illustrated in FIG. 1. The color generated by an interferometric modulator display element (i.e., the hue) may be expressed in terms of CIE tri-stimulus color parameters. CIE tri-stimulus parameters and methods for obtaining them are well known in the art. In some embodiments, color parameter pairs such as (u′,v′) may be used to graphically depict a given perceived color (i.e., hue) on a two-dimensional CIE color space plot.

As the gap in an interferometric modulator display element such as the interferometric modulator structure illustrated in FIG. 1 is varied, the reflected color traces out a spiral on the CIE chromaticity diagram shown as the solid curve 200 in FIG. 9. Each point on the curve 200 represents the color generated by the interferometric modulator structure having a particular gap. The gap distance increases moving clockwise around the curve 200.

In one embodiment, both the fixed color display element 104 and the variable color display element 106 comprise the interferometric modulator structure as illustrated in FIG. 1. The fixed color display element is capable of generating only one fixed color, but that color can come from any point along the curve 200. The shape and position of the curve 200 may be varied depending on the type of material used in construction of the fixed color display element. Curve 200 represents the color design space from which the fixed color of the fixed color display element is chosen and the corresponding gap distances of the subpixels 104 determined. The variable color display element is capable of generating one tunable color, which can be any point along the curve 200, variably controlled by one or more external signals. Depending on the embodiment, the variable color display element may have a curve 200 different from the fixed color display element.

FIG. 9 also indicates the color parameters for the limit of human perception as defined by the CIE 1976 color standard (long dashed line 202); red 204, blue 206, and green 208 EBU phosphor color standards (squares); and the primary colors typically used for the subpixels of a reflective TFT LCD display 212, 214, and 216 (diamonds). The range of perceived colors that can be produced by a given display is often referred to as “color gamut”. In one embodiment, a color display may have a color gamut including at least three primary colors; each is substantially close to the corresponding EBU phosphor primary color. Other embodiments may provide a color display of a different color gamut.

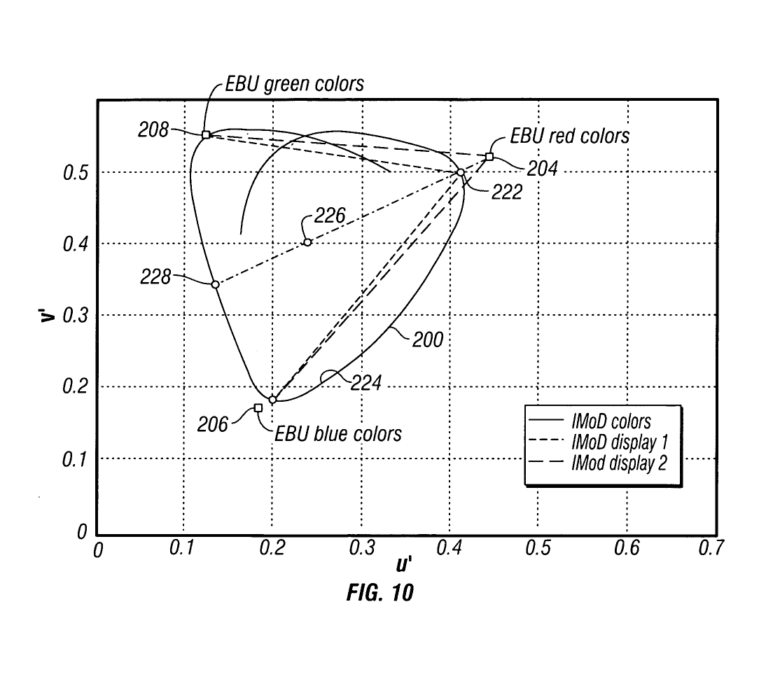

FIG. 10 shows a CIE color space plot with the color gamut of one embodiment of a color display 100 as illustrated in FIG. 8. In the exemplary embodiment, the fixed color display element 104 is configured to generate a fixed color 222. In certain embodiments, the fixed color is chosen such that it is substantially close to an EBU phosphor primary color. In one embodiment, the variable color display element 106 is configured to generate a tunable color which can be any point along a portion of the curve 200 between two colors substantially close to other two EBU phosphor primary colors.

In certain embodiments, it may be desirable to configure the fixed color display element 104 to generate a red color, since an additional filter may be used to improve the saturation of the red color. The saturation is defined herein as the purity of a desired primary color hue. For example, an additional gold layer may be deposited on the movable reflective layer 14a of the fixed color display element 104 (see FIG. 1). One of skill in the art will recognize that alternative materials may be used to achieve the same result. In one embodiment, an additional filter incorporated in the fixed color display element 104 improves the saturation of the red color displayed by the interferometric modulator 104, moving the red color from the color 222 to the color 204. As a result, the color gamut of the pixel 102 also increases.

In the exemplary embodiment, the fixed color display element 104 is configured to generate a red color 222. The variable color display element 106 is configured to generate a tunable color which can be any point along the portion of curve 200 between green color 208 (which is also the EBU phosphor green color) and blue color 224. It should be noted that in other embodiments, the green color of the variable color display element 106 may be different from the EBU phosphor green color. As will be illustrated below, the pixel 102 is capable of generating any color within a curve defined by the line connecting 222 and 208, the line connecting 222 and 224, and the portion of the curve 200 between 208 and 224. In other words, the area within the curve is the color gamut of the pixel 102.

To cause the pixel 102 to be perceived as generating a particular color 226, which may be any color within the color gamut of the pixel 102, the variable color display element 106 is tuned to a color 228, which is located on the portion of curve 200 between 208 and 224, such that the perceivable color generated by the pixel 102 is on a line between the color 222 and 228. The position of the perceivable color of the pixel 102 along the ling connecting 228 and 222 depends on the ratio of the brightness of the fixed color display element 104 to the brightness of the variable color display element 106. The pixel 102 is to be perceived by a viewer to generate a color 226 when appropriate control of the brightness of the fixed color display element 104 and the variable color display element 106 is applied. For example, if the color 226 is located at the midpoint of the line between the color 228 and 222, the brightness of the fixed color display element 104 and the variable color display element 106 should be substantially the same to generate the color 226. When the color 226 moves toward the color 222 from the midpoint, the ratio of the brightness of the fixed color display element 104 to the brightness of the variable color display element 106 should be increased. When the color 226 moves away from the color 222 from the midpoint, the ratio should be decreased. When a different color 226 is required to be generated by the pixel 102, the variable color display element 106 is tuned to generate a new color 228 such that the new color 226 again falls on a line between the new color 228 and the fixed color 222.

In addition to controlling wavelengths of light reflected by the subpixels, the brightness of the subpixels also needs to be controlled. There are many ways to vary the brightness of each subpixel independently. The brightness may be adjusted by, for example, temporal modulation (alternating between color and black), or spatial modulation (dividing the subpixels further so that each subpixel may be partially or completely black). In one embodiment using temporal modulation, each subpixel is variably controlled to reflect light for a selected portion of a display period, which may be selected to be, for example, shorter than the flicker fusion interval of the human eye, or around 15 ms. For example, to achieve a 2-to-1 brightness ratio, the subpixel 104 is controlled to reflect light for a portion of a display period which is twice as long as a portion of the display period for which the subpixel 106 is controlled to reflect light. It may be desirable to set at least one of the subpixels to reflect light for the whole display period in order to maximize the perceived brightness of the pixel 102. In an embodiment using spatial modulation, each subpixel further comprises a plurality of portions each of which can be in either bright or dark state. The brightness of each subpixel is varied by controlling how many portions are in bright state. The more portions each subpixel has, the finer control may be realized over the brightness of each subpixel.

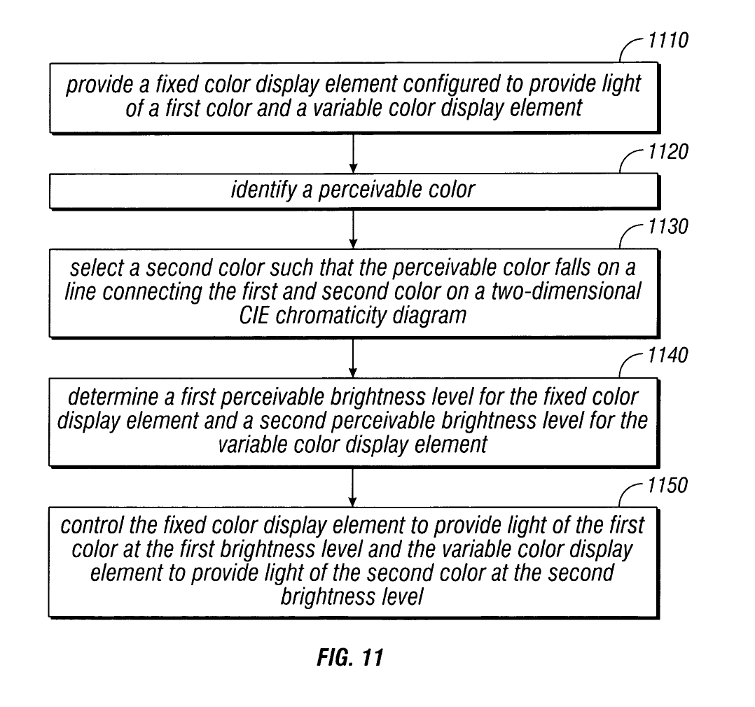

FIG. 11 is a flowchart illustrating one embodiment of a method of displaying a desired perceivable color in a display 100 as illustrated in FIG. 8. Depending on the embodiment, certain steps of the method may be removed, merged together, or rearranged in order. Though the steps below are described as being performed by the array driver 22, these steps can also be performed by the processor 21 (see FIG. 2).

The method starts at a block 1110, wherein a pixel 102 as illustrated in FIG. 8 is provided. The pixel 102 comprises a fixed color display element 104 configured to provide light of a fixed first color. The pixel 102 further comprises a variable color display element 106 configured to provide light of a variable second color.

Next at a block 1120, the array driver 22 in FIG. 2 identifies the desired perceivable color to be generated by the pixel 102. Moving to a block 1130, the array driver 22 selects a second color such that the desired perceivable color falls on a line between the first and second color on a two-dimensional CIE color space plot. Next at a block 1140, the array driver 22 further determines a first brightness level of the first color and a second brightness level of the second color such that the first color and second color collectively provide light of the desired perceivable color.

Last at a block 1150, the array driver 22 generates appropriate signals, controlling the fixed color display element subpixel 104 to provide light of a first color at the first brightness level and the variable color display element subpixel 106 to provide light of a second color at the second brightness level.

As discussed above, there are many ways to control the brightness level of the subpixel 104 and 106. In one embodiment, each subpixel is variably controlled to reflect light for a portion of each display period. It may be desirable to set at least one of the subpixels to reflect light for the whole display period in order to maximize the perceived brightness of the pixel 102. In another embodiment, each subpixel further comprises a plurality of portions each of which can be in either bright or dark state. The brightness of each subpixel is varied by controlling how many portions are in bright state. By adjusting the brightness ratio of the first color to the second color, the position of the perceivable color on the line that connects the first and second color on a two-dimensional CIE chromaticity diagram may be controlled. For example, the perceivable color will be closer to the color that is displayed longer or with more portions in bright state.

Also, each subpixel may be in the dark state for the whole display period. If one of the two subpixels 104 and 106 is in the dark state, the perceivable color generated by the pixel 102 is the color displayed by the other subpixel. If both subpixels are in the dark date, the pixel is perceived to be in the dark state as well.

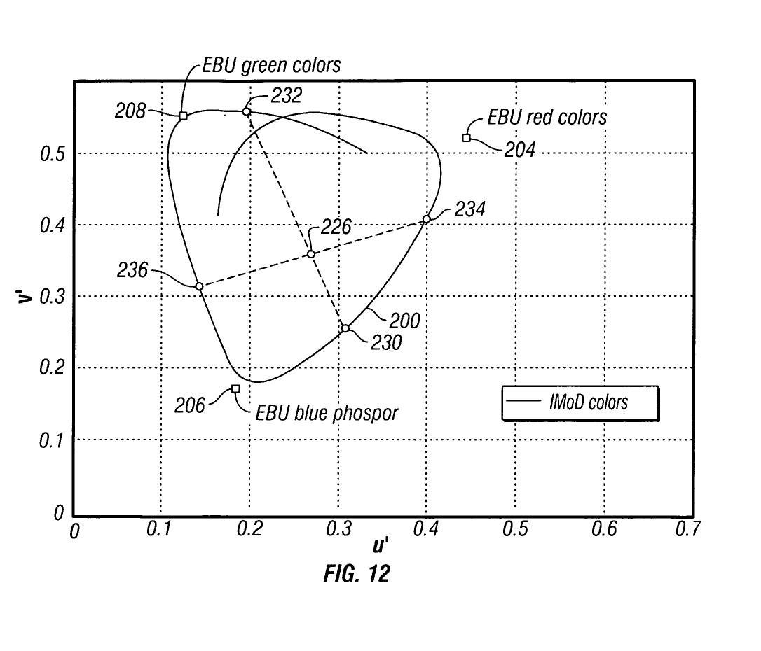

FIG. 12 shows a CIE color space plot with the possible set of colors that can be generated by another embodiment of a color display wherein each pixel comprises two or less subpixels. Another embodiment of a color display wherein each pixel comprises two or less subpixels may be achieved by modifying the embodiment illustrated in FIG. 8. The resulting embodiment of the display has the same structure as the embodiment illustrated in FIG. 8, except that the subpixel 104 is a variable color display element. Each of the subpixels 104 and 106 now can generate a tunable color which can be any point on curve 200 in FIG. 9.

In order for the pixel 102 to generate a perceivable color 226, which can be any point within the curve 200, the variable color display element 104 and 106 are respectively tuned to generate a color 230 and 232 such that the perceivable color 226 is located on a line between the color 230 and 232. Methods as discussed with regard to FIG. 10 can be similarly applied here to vary the brightness of the subpixels 104 and 106 such that the first color and second color collectively provide light of the desired perceivable color. When a different color 226 is required to be generated by the pixel 102, the variable color display elements 104 and 106 are tuned to generate a new color 230 and 232 such that the new color 226 again falls on a line between the new color 230 and 232. It will be appreciated that the pixel 102 can be controlled to generate any color within the curve 200 in this fashion. Therefore, the space within the curve 200 is the color gamut of the pixel 102.

It will be appreciated that there are many different combinations of the color 230 and 232 which can collectively generate a particular perceivable color 226. In one embodiment, one combination is randomly picked to generate the perceivable color 226. In other embodiments, a particular combination of the color 230 and 232 is chosen such that the perceivable color 226 is the approximate midpoint on the line between the color 230 and 232. It should be noted that more than one combination of the color 230 and 232 may satisfy this criterion. Since both colors 230 and 232 can move, such a combination is available for almost any color 226 within the curve 200. For example, the color 226 in FIG. 12 is the midpoint of the line between the colors 234 and 236. The colors 234 and 236 only need to have approximately the same brightness level to generate the color 226.

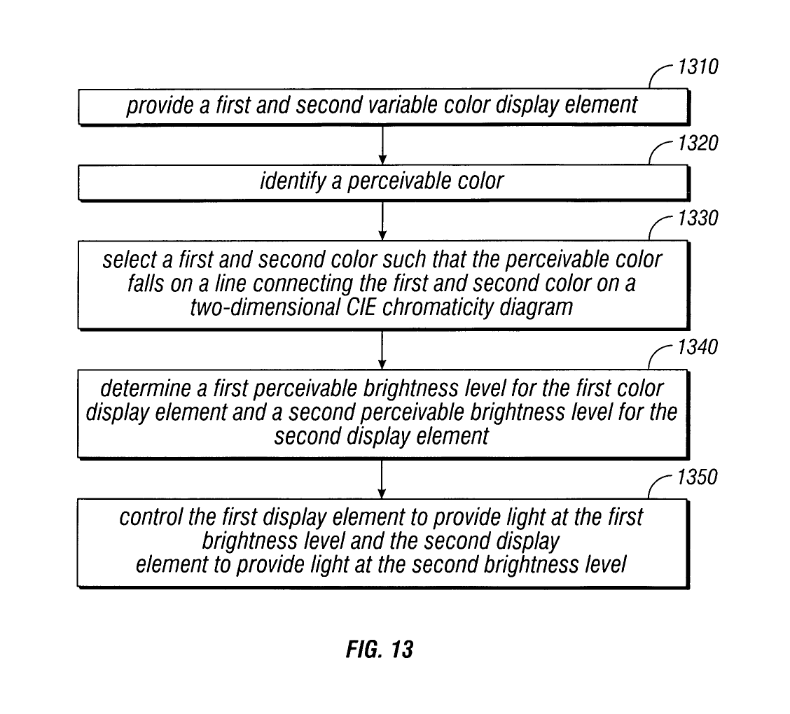

FIG. 13 is a flowchart illustrating one embodiment of a method of displaying a desired perceivable color in a display as discussed above with regard to FIG. 12. Depending on the embodiment, certain steps of the method may be removed, merged together, or rearranged in order. Though the steps below are described as being performed by the array driver 22, these steps can also be performed by the processor 21 (see FIG. 2).

The method starts at a block 1310, wherein a pixel 102 is provided, comprising two variable color display elements 104 and 106 each configured to provide light of a variable color.

Next at a block 1320, the array driver 22 in FIG. 2 identifies the desired perceivable color to be generated by the pixel 102. Moving to a block 1330, the array driver 22 selects a first and second color such that the desired perceivable color falls on a line between the first and second color on a two-dimensional CIE color space plot. Next at a block 1340, the array driver 22 further determines a first brightness level of the first color and a second brightness level of the second color such that the first color and second color collectively provide light of the desired perceivable color and brightness.

Last at a block 1350, the array driver 22 generates appropriate signals, controlling the variable color display element 104 to provide light of a first color at the first brightness level and the variable color display element 106 to provide light of a second color at the second brightness level. Methods of controlling the brightness level of each subpixel as discussed above with regard to FIG. 11 can be similarly applied here.

In another embodiment, the method comprises the same blocks 1310 and 1320 as discussed in the exemplary embodiment. Next at block 1330, the array driver 22 selects a first and second color such that the desired perceivable color is substantially the midpoint of the line between the first and second color. The method then moves to a block 1350, wherein the array driver 22 generates appropriate signals, controlling the variable color display element 104 to provide light of a first color and the variable color display element to provide light of a second color.

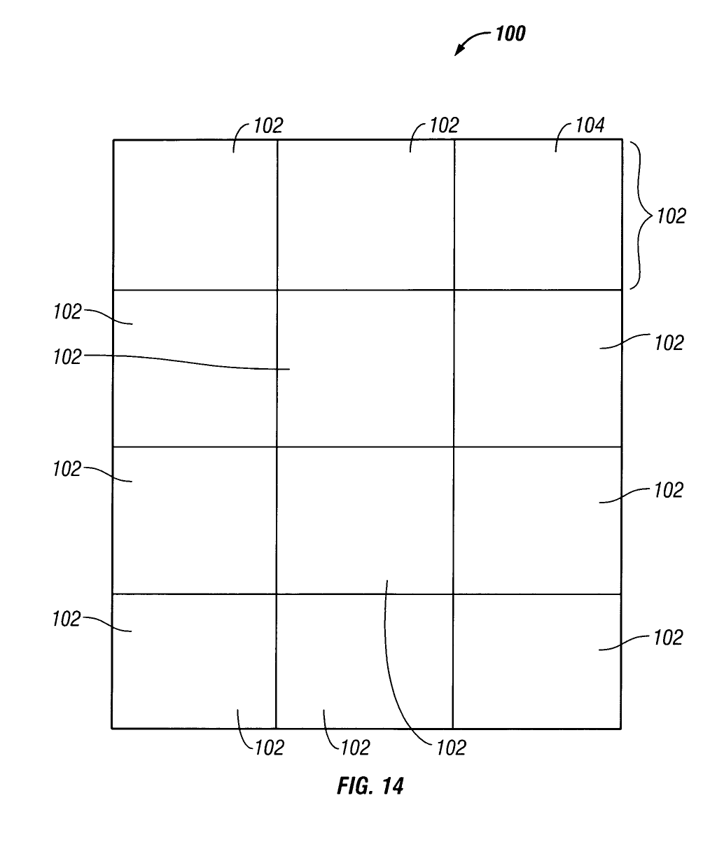

FIG. 14 illustrates another embodiment of a color display wherein each pixel comprises two or less subpixels. In the exemplary embodiment, each pixel in the display comprises a variable color display element 104, instead of two variable color display elements in the embodiment discussed above with regard to FIG. 12.

In order for the pixel 102 to generate a perceivable color 226, which can be any color within the curve 200 (see FIG. 12), a first and a second color 230 and 232 are selected similar to the discussion with regard to FIG. 12. Each display period is divided into two sub-periods. During the first sub-period, the variable color display element 104 is controlled to provide light of a first color. During the second sub-period, the variable color display element 106 is controlled to provide light of a second color. In this fashion, the pixel 102 can be controlled to generate any light within the curve 200 similar to the discussion with regard to FIG. 12.

In other embodiments, the display period may be divided into more than two sub-periods. For example, each display period may be divided into three sub-periods. In addition to one sub-period for the first and second colors, a third sub-period is added during which both the display elements 104 and 106 are in dark state. The third sub-period may be skipped for full brightness of the pixel 102. The first two sub-periods may be skipped for full darkness of the pixel 102.

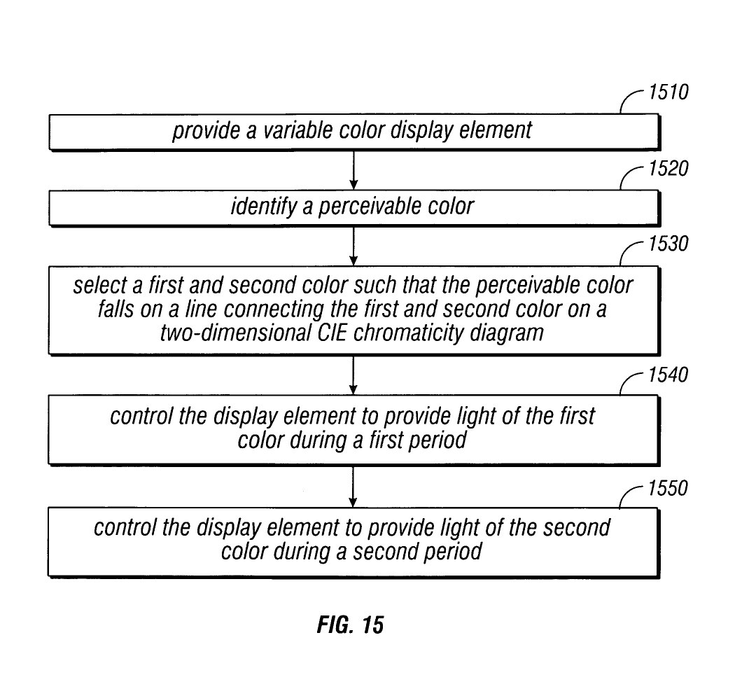

FIG. 15 is a flowchart illustrating one embodiment of a method of displaying a desired perceivable color in a display as illustrated in FIG. 14. Depending on the embodiment, certain steps of the method may be removed, merged together, or rearranged in order. Though the steps below are described as being performed by the array driver 22, these steps can also be performed by the processor 21 (see FIG. 2).

The method starts at a block 1510, wherein a pixel 102 as illustrated in FIG. 14 is provided, comprising a variable color display elements 104 configured to provide light of a variable color.

Next at a block 1520, the array driver 22 in FIG. 2 identifies the desired perceivable color to be generated by the pixel 102. Moving to a block 1530, the array driver 22 selects a first and second color such that the desired perceivable color falls on a line between the first and second color on a two-dimensional CIE color space plot. Next at a block 1540, the array driver 22 further determines a first brightness level of the first color and a second brightness level of the second color such that the first color and second color collectively provide light of the desired perceivable color and brightness.

Last at a block 1550, the array driver 22 generates appropriate control signals to array driver 22, controlling the variable color display element 104 to provide light of a first color at the first brightness level during a first sub-period of a display period and to provide light of a second color at the second brightness level during a second sub-period of the display period. In one embodiment, the display period is divided between the first and the second sub-period. In other embodiments, the display period may additionally include one or more sub-periods during which no light is displayed.

In one embodiment, the desired brightness ratio of the first color to the second color is adjusted by controlling the lengths of the first and second sub-periods. In another embodiment, the first sub-period is of a length substantially equal to the length of the second sub-period. The subpixel 104 further comprises a plurality of portions each of which can be in either bright or dark state. The brightness of each subpixel is varied by controlling how many portions are in bright state.

In another embodiment, the method comprises the same blocks 1510 and 1520 as discussed in the exemplary embodiment. Next at block 1530, the array driver 22 selects a first and second color such that the desired perceivable color is substantially the midpoint of the line between the first and second color. The method then moves to a block 1550, wherein the array driver 22 generates appropriate control signals to the array driver 22, controlling the variable color display element 104 to provide light of a first color for a first sub-period of a display period and the variable color display element to provide light of a second color for a second sub-period of the display period. The first sub-period is of the same length as the second sub-period such that the perceivable color generated by the display element 102 to be approximately the midpoint between the first and second color, i.e., the desired perceivable color. In one embodiment, the display period is divided between the first and the second sub-period. In other embodiments, the display period may additionally include one or more sub-periods during which no light is displayed.

FIGS. 16-19 illustrate certain embodiments of an analog MEMS display element. FIG. 16A illustrates an embodiment of a MEMS device 500 in a side cross-sectional view. The MEMS device 500 is constructed on a substrate 501 made in one embodiment of glass although not limited thereto. An optical layer 503 is formed on the substrate 501. The optical layer 503 acts as a partial mirror as it both reflects and transmits some of the incident light. In one embodiment, the optical layer 503 may be conductive and may be patterned into rows (not illustrated). In one embodiment, a dielectric layer 505 may be formed over the optical layer 503. A mechanical layer 507 is located such that one of its surfaces faces the dielectric layer 505 in a substantially parallel plane and spaced relationship. The dielectric layer 505 prevents electrical shortage of the optical layer 503 and mechanical layer 507 in a driven state, which will be described below, and further protects the two layers 503 and 507 from damage by impact when the mechanical layer is driven to contact the optical layer 503.

In one embodiment, the surface 508 of the mechanical layer 507 opposing the dielectric layer 505 is highly reflective and acts as a mirror. The reflective surface 508 of the mechanical layer is referred to as the “mirror surface”. Also, the mechanical layer 507 may be conductive and patterned into columns (not illustrated). A physical cavity 509 is created between the dielectric layer 505 and the mechanical layer 507. The cavity 509 is often referred to as an “interferometric cavity” although a depth 513 of the interferometric cavity is defined between the mechanical layer 507 and the optical layer 503 rather than the dielectric layer 505. One of ordinary skill in the art will appreciate processes for manufacturing of the MEMS device 500 and an array thereof, which is a two-dimensional arrangement of a plurality of the MEMS devices 500 (not illustrated).

The MEMS device 500 is operated by applying or not applying an electric potential between the optical layer 503 and the mechanical layer 507. In FIG. 16A, the MEMS device 500 is illustrated in the configuration produced when no voltage is applied between the optical layer 503 and mechanical layer 507, which is referred to as an “undriven state” or “undriven configuration”. In this state, light that is incident on the MEMS device 500 through the substrate 501 is interferometrically modulated, which will be well appreciated by one of ordinary skill in the art. Depending on the interferometric cavity depth 513, a certain wavelength of the light is reflected to the viewer. If the selected wavelength of the light is visible, a colored light corresponding to the wavelength is displayed.

On the other hand, by applying a voltage between the optical layer 503 and the mechanical layer 507, which is generally greater than a drive threshold voltage, the mechanical layer 507 is driven to deform and contact the dielectric layer 505, as illustrated in FIG. 16B. This configuration of the MEMS device 500 is referred to as a “driven state” or “driven configuration”. In this driven state, the MEMS device 500 is in an induced absorption mode, in which most of the light incident on the substrate 501 is absorbed with the result that the surface 511 of the substrate 500 appears black to the viewer. Generally, the other MEMS devices disclosed herein and their variants will operate in the same or similar ways, unless specifically discussed otherwise. In another configuration, the “driven state” could also result in an interferometric color reflection depending on the thickness of the dielectric layer 505.

FIGS. 16C and 16D illustrate another embodiment of a MEMS device 600. As illustrated, the MEMS device 600 is constructed on a substrate 601 and comprises an optical layer 603, dielectric layer 605 and a mechanical layer 607. The substrate 601, optical layer 603 and dielectric layer 605 have generally the same characteristics and features as the respective layers 501, 503 and 505 of the MEMS device 500, unless specifically stated otherwise. In the MEMS device 600, a mirror 611 is provided between the mechanical layer 607 and the dielectric layer 603. The mirror 611 has a highly reflective surface 608 and is electrically conductive. As illustrated, the mirror 611 of the MEMS device 600 is mechanically and electrically connected to the mechanical layer 607 via a connection 615. Unlike the mechanical layer 507 of FIGS. 16A and 16B, the mechanical layer 607 does not have to have a reflective surface. Thus, in the MEMS device 600, the mechanical layer 607 is dedicated to the function of mechanical movement by deformation, and the mirror 611 is dedicated to the function of a mirror as an optical element. One of ordinary skill in the art will appreciate processes available for manufacturing the MEMS device 600 and an array thereof comprising a plurality of MEMS devices 600 arranged on a plane.

An interferometric cavity 609 is formed between the mirror surface 608 and the dielectric layer 605. The depth of the cavity 613 is the distance between the mirror surface 608 and the optical layer 603 (not the dielectric layer 605). In FIG. 16C, the MEMS device 600 is illustrated in the configuration of its undriven state, where no voltage is applied between the optical layer 603 and the mechanical layer 607 (or the mirror 611). In FIG. 16D, on the other hand, the MEMS device 600 is in its driven state, where a voltage greater than a threshold voltage is applied between the optical layer 603 and the mechanical layer 607 (or the mirror 611). As illustrated, the mechanical layer 607 deforms and the reflective surface 408 of the mirror (hereinafter “mirror surface” 608) contacts the dielectric layer 605.

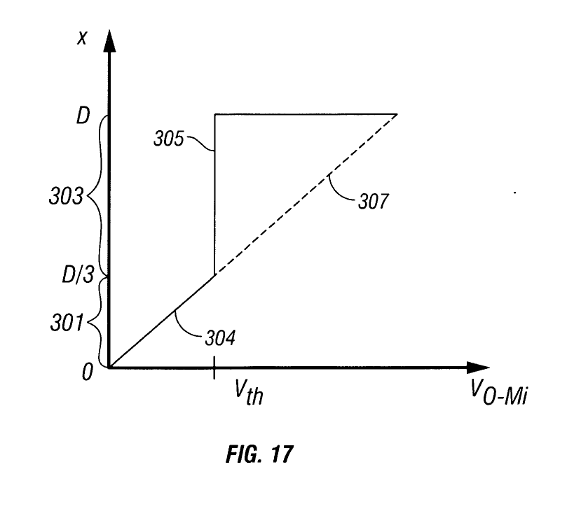

FIG. 17 illustrates the relationship between the movement of the mirror surface 508/608 of an interferometric modulator and the electric potential difference between the optical layer 503/603 and the mirror surface 508/608 of the interferometric modulator. The horizontal axis represents the voltage (V_{O-Mi}), which is the difference between the voltage (V_{O}) of the optical layer 503/603 and the voltage (V_{Mi}) of the mirror surface 508/608. The voltage applied to the mirror surface 508/608 is the same (equipotential) as that of the mechanical layer 507/607 as they are electrically connected. The vertical axis represents the movement or displacement (x) of the mirror surface 508/608 from its position in its undriven state in the direction toward the optical layer 503/603 and substantially perpendicular to the mirror surface 508/608 in its undriven state.

When no voltage is applied between the optical layer 503/603 and the mechanical layer 507/607, the MEMS device is in its undriven state and the mirror surface does not move (x=0). When a voltage is applied between the optical layer 503/603 and mechanical layer 507/607, the mechanical layer 507/607 is driven to deform, and accordingly the mirror surface 508/608 moves toward the optical layer 503/603. The displacement 304 of the mirror surface 508/608 is a function of the voltage difference (V_{O-Mi}) until it reaches a threshold voltage (Vₜₕ). When the voltage difference (V_{O-Mi}) reaches the threshold voltage (Vₜₕ), a small increase of the voltage difference will make a sudden deformation of the mechanical layer 507/607, resulting in the sudden displacement 305 of mirror surface 508/608 toward the dielectric layer 505/605 (x=D). The maximum displacement (xₘₐₓ=D) is the distance between the dielectric layer 505/605 and the mirror surface 508/608 in the undriven state (x=0) of the MEMS device 500/600. The maximum displacement (D) is shorter than the maximum depth of the interferometric cavity 513 by the thickness of the dielectric layer 505/605. In some embodiments, for example, the displacement of the mirror surface (Dₜₕ) at the threshold voltage is about one third (⅓) of the maximum displacement (D).

In summary, the mirror surface 508/608 responds to the changes of the voltage difference (V_{O-Mi}) from its undriven position up until about one third of the maximum displacement (D). Thus, in a first segment 301 (0≦x≦D/3), the interferometric cavity depth 513/613 of the MEMS device 500/600 is highly tunable by changing the voltage (V_{O-Mi}) applied between the optical layers 503/603 and the mechanical layer 507/607. On the other hand, however, the mirror surface 508/608 rapidly moves in reply to a very small change in the voltage difference (V_{O-Mi}) when the voltage difference (V_{O-Mi}) becomes greater than the threshold voltage (Vₜₕ). Accordingly, in a second segment 303 (D/3≦x≦D), tuning of the interferometric cavity depth 513/613 by changing the voltage difference (V_{O-Mi}) is generally difficult to accomplish.

This phenomenon may be explained by equilibrium of forces and counter forces exerted on a moving part although the invention and the embodiments thereof are not bound by any theories. The equilibrium of the forces is now described in more detail with reference to the MEMS device 500 of FIGS. 16A and 16B. In the MEMS device 500, the major forces acting on the mirror surface 508, which is a moving part in question, are 1) an electrostatic force between the optical layer 503 and the mechanical layer 507, and 2) a mechanical restoration force of the mechanical layer 507. The electrostatic force between the optical layer 503 and the mechanical layer 507 is dependent on the potential difference between the two layers 503 and 507. Although the electrostatic force may be created as either attractive or repulsive, it is desirable to have the force maintained as attractive in the operation of the MEMS device 500.

In response to the electrostatic force between the two layers 503 and 507, the mechanical layer 507 (being less rigid than the optical layer 503 in this embodiment) moves towards the optical layer 503. In other embodiments, either or both of the layers 503 and 507 may move toward the other. The electrostatic force is represented by the following equations:

$$\begin{matrix}{F}_{eO - Mi} = \frac{d}{d x} ( \frac{1}{2} {CV}_{O - Mi}^{2} ) & Equation 1 \\ {C}_{O - Mi} = \frac{ɛ A}{d - x} & Equation 2\end{matrix}$$

In the foregoing equations, F_{eO-Mi} represents electrostatic force exerted on the mirror surface 508 caused by the voltage applied between the optical layer 503 and the mirror surface 508. “C_{O-Mi}” represents capacitance between two electrodes, which are the optical layer 503 and the mirror surface 508. “ε” is the effective permittivity of the materials placed between two electrodes, which are again the optical layer 503 and the mirror surface 508. In the foregoing equations, “A” is an effective overlapping area of the two opposing electrodes, which is in this case the area of the mirror surface 508. The parameter “d” is a distance between two opposing electrodes, which is in this case the distance 413 between the mirror surface 508 and the optical layer 503 in the undriven configuration as illustrated in FIG. 1. “x” represents a displacement of the mirror surface 508 toward the optical layer 503 from its position in the undriven configuration.

The mechanical restoration force exists in the mechanical layer 507 when it has changed its configuration from its most stable configuration. For example, the mechanical layer 507 is in its most stable configuration when the MEMS device 500 is in the undriven state (x=0). Then, if the MEMS device 500 is in a driven position (x>0), the mechanical restoration force is exerted on the mechanical layer 507 and its mirror surface 508 in the direction away from the optical layer 503 in favor of the undriven configuration. The mechanical restoration force depends on the properties of the material used in the mechanical layer 507 and the geometrical configuration of the mechanical layer 507. One of ordinary skill in the art will appreciate the relationship between the geometrical configuration of the mechanical layer 507 and the restoration force upon selection of an appropriate material for the mechanical layer 507. Also, one of ordinary skill in the art will be able to design the geometrical configuration of the mechanical layer 507 to create a desired size of the restoration force of the mechanical layer upon the selection of an appropriate material.

In the first segment 301 (0≦x≦D/3) in FIG. 17, for example, the attractive electrostatic force created by the voltage (V_{O-Mi}) applied between the layers 503 and 507 substantially equilibrates with the mechanical restoration force of the mechanical layer 507 at any point of the first segment 301. This is a primary reason why the location of the mirror surface 508 (accordingly, the interferometric cavity depth 513) is tunable by changing the voltage difference (V_{O-Mi}). In the second segment 303 (D/3≦x≦D), however, the attractive electrostatic force between the optical layer 503 and the mechanical layer 507 is significantly larger than the mechanical restoration force in the opposite direction. Thus, a slight increase of the voltage (V_{O-Mi}) will result in a sudden movement of the mechanical layer 507, and therefore the mirror surface 508. One of ordinary skill in the art will appreciate that the same explanation may be made with regard to the operation of the MEMS device 600 of FIGS. 16C and 16D with modifications in view of the architectural differences.

Embodiments of the invention enable tuning of the interferometric cavity depth of a MEMS device in both of the first and second segments 301 and 303 (023 x≦D). To achieve the tuning in the second segment 303 (D/3≦x≦D), embodiments of the invention may use one or more forces other than the forces identified above, which are the mechanical restoration force of a mechanical layer and the electrostatic force between a mirror surface and an optical layer. Embodiments of the invention make displacement of the mirror surface have a tunable relationship, preferably a substantially linear relationship, with changes in voltages applied between one or more sets of electrodes.

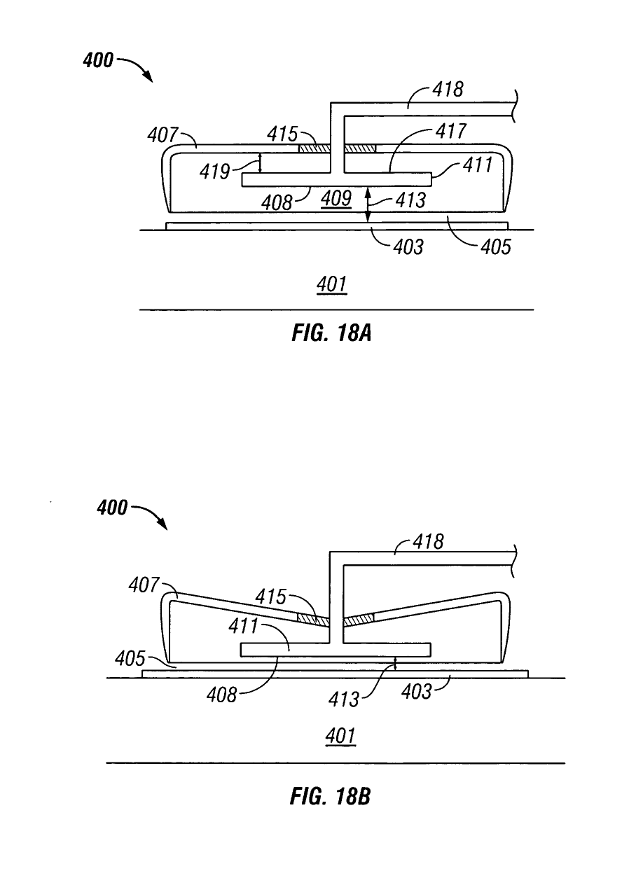

In one embodiment illustrated in FIG. 18A, a MEMS device 400 is formed on a substrate 401. The MEMS device 400 comprises an optical layer 403, a dielectric layer 405 and a mechanical layer 407. The substrate 401, optical layer 403 and dielectric layer 405 have generally the same characteristics and features as the corresponding layers of the MEMS device 500, unless specifically stated otherwise. The mechanical layer 407 comprises an area of insulation material, which is referred to as an insulator 415. A mirror 411 is located between the dielectric layer 403 and the mechanical layer 407. The mirror has a highly reflective surface 408 and is made of a conductive material. The mirror 411 is mechanically connected to the mechanical layer 407 via the insulator 415. Unlike the mirror 611 in the MEMS device 600 illustrated in FIG. 16C, the mirror 411 is electrically disconnected or isolated from the mechanical layer 407 while mechanically connected thereto by the insulator 415. With a conductive extension 418, the mirror 411 may be electrically connected to another electric voltage or current source, which is independent of the mechanical layer 407. The mechanical layer 407 is conductive and patterned into columns (not illustrated). A cavity 409 is formed between the mirror surface 408 and the dielectric layer 405. The depth of the interferometric cavity 413 is the distance between the mirror surface 408 and the optical layer 403 (not the dielectric layer 405).

One of ordinary skill in the art will appreciate processes available for the manufacturing of the MEMS device 400 and an array thereof comprising a plurality of the MEMS devices 404 arranged in a two-dimensional plane. Particularly, one of ordinary skill in the art will appreciate processes and materials available for forming the insulator 415 in the middle of the mechanical layer 407 and for forming the mirror 411 so as to be mechanically connected to but electrically isolated from the mechanical layer.

In one embodiment, movement of the mirror surface 408 within the first segment 301 (0≦x≦D/3 in FIG. 17) and within the second segment 303 (D/3≦x≦D in FIG. 17) is tuned or controlled by electric potential differences between different two or more sets of electrodes. More specifically, movement of the mirror surface 408 within the first segment 301 (0≦x≦D/3) is tuned by the difference between a voltage (V_{Mi}) of the mirror 411 and a voltage (V_{O}) of the optical layer 403 while maintaining a voltage (V_{Mi}) of the mirror 411 and a voltage (V_{Me}) of the mechanical layer 407 at the same level. The movement of the mirror surface 408 within the second segment 303 (D/3≦x≦D) may be tuned by the difference between a voltage (V_{Mi}) of the mirror 411 and a voltage (V_{Me}) of the mechanical layer 407 while maintaining or changing a voltage difference between the mirror 411 and the optical layer 403.

The displacement of the mirror 411 or mirror surface 408 in response to the electric potential difference between the optical layer 403 and the mirror 411 follows the relationship discussed above with reference to FIG. 17 if the voltage at the mirror 411 is maintained the same as the mechanical layer 407. Thus, if the voltage (V_{Mi}) of the mirror 411 is maintained the same as the voltage (V_{Me}) of the mechanical layer 407, the displacement of the mirror 411 within the first segment 301 is generally proportional to the voltage (V_{O-Mi}), which is the difference between the voltage (V_{O}) of the optical layer 403 and the voltage (V_{Mi}) of the mirror 411. The displacement of the mirror is represented by the solid line 304 of FIG. 17. As discussed above, in the first segment 301, the proportional or tunable relationship is accomplished by equilibrium of the mechanical restoration force in the mechanical layer 407 with the attractive electrostatic force between the mirror 411 and the optical layer 403.

In the second segment 303 (D/3≦x≦D), if the voltage of the mirror 411 is maintained the same as the mechanical layer 407 and the voltage difference (V_{O-Mi}) increases beyond the threshold voltage (Vₜₕ), a strong attractive electrostatic force between the mirror 411 and the optical layer 403 will break the equilibrium. Thus, the displacement of the mirror in the second segment 303 by an infinitesimal increase of the voltage (V_{O-Mi}) beyond the threshold voltage (Vₜₕ) is represented by the solid line 305 of FIG. 17.

To maintain an equilibrium state in the second segment 303 (D/3≦x≦D), in one embodiment, the electrostatic attractive force between the optical layer 403 and the mirror 411 created by the potential difference (V_{O-Mi}) may be balanced by the mechanical restoration force of the mechanical layer 407 and by an electrostatic force created by the voltage (V_{Mi-Me}), which is the difference between the voltage (V_{Mi}) of the mirror 411 and the voltage (V_{Me}) of the mechanical layer 407. In this embodiment, equilibrium of the forces exerted to the mirror 411 can be maintained throughout the second segment 303 or at least a portion of the second segment. Thus, the displacement of the mirror 411 may be tunable by changing the voltage (V_{Mi-Me}). The dashed line 307 of FIG. 17 represents an example of the tunable displacement of the mirror 411 in the second segment.

The electrostatic force between the mirror 411 and the mechanical layer 407 is represented by the following equation:

$$\begin{matrix}{F}_{eMi - Me} = \frac{d}{d x} ( \frac{1}{2} {CV}_{Mi - Me}^{2} ) & Equation 3 \\ {C}_{Mi - Me} = \frac{ɛ A}{{d}^{′} + x} & Equation 4\end{matrix}$$

In the foregoing equations, F_{eMi-Me} represents the electrostatic force exerted on the mirror 514 created by the voltage (V_{Mi-Me}) applied between the mechanical layer 407 and the mirror 411. “C_{Mi-Me}” represents capacitance between two electrodes, which are the mirror 514 and the mechanical layer 407. “ε” is the effective permittivity of the materials located between two electrodes, which are again the mirror 411 and the mechanical layer 407. “A” is an effective overlapping area of the two opposing electrodes, which is in this case the area of a surface 417 of the mirror facing the mechanical layer 407. “d′” is a distance between the two electrodes, which is in this case the distance 419 between the mechanical layer 407 and the surface 417 of the mirror in the undriven configuration as illustrated in FIG. 18A. “x” represents the displacement of the mirror 411 or mirror surface 408 in the direction toward the optical layer 403 from its position in the undriven configuration.

In another embodiment, the location of the mirror surface 408 (and therefore the interferometric cavity depth 513) may be tuned by creating equilibrium among all the forces exerted on the mirror 411. In other words, the net force applied to the mirror 411 is substantially zero at any position of the mirror 411. With regard to the electrostatic forces, for example, there are electrostatic forces based on the voltage (V_{O-Mi}) between the mirror 411 and the optical layer 403, the voltage (V_{Mi-Me}) between the mirror 411 and the mechanical layer 407, and the voltage (V_{Me-O}) between the mechanical layer 407 and the optical layer 403. With regard to the mechanical restoring forces, for example, there may be mechanical restoring forces based on the tension formed in the mechanical layer 407 and the tension formed in the conductive extension 418 when the mirror 411 is displaced at all from the undriven position (x=0) toward the driven position (x=D). For example, the relationship among the forces may be represented by the following equation.

F_{eO-Mi}+F_{eO-Me}=F_{mR}+F_{eMi-Me} Equation 5

In the foregoing equation, “F_{mR}” represents the mechanical restoration force of the mechanical layer 407, which is determined by the configuration and material of the mechanical layer 407. “F_{eO-Mi}” represents the electrostatic force created by the voltage difference (V_{O-Mi}) between the optical layer 403 and the mirror 411. See Equation 1 above. “F_{eMi-Me}” represents the electrostatic force created by the voltage (V_{Mi-Me}) applied between the mirror 411 and the mechanical layer 407. See Equation 3 above. “F_{eO-Me}” represents the electrostatic force created by the voltage (V_{O-Me}) applied between the optical layer 403 and the mechanical layer 407. Generally, the force “F_{eO-Me}” will be smaller than the other forces in Equation 5 as the mirror 411 shields the mechanical layer 407 from the optical layer 403. One of ordinary skill in the art will be able to formulate an equation representing “F_{eO-Me}” in view of the slanting or deforming configuration of the mechanical layer 407 when the MEMS device 400 is in a driven state as illustrated in FIG. 18B. One of ordinary skill in the art will be able to formulate an equation more accurately representing the equilibrium of various forces applied to the mirror in a particular MEMS architecture by considering additional forces in the MEMS device 400. For example, if the extension 418 of the mirror 411 is structurally connected with a part of the MEMS device 400 or the array thereof (not illustrated), mechanical forces caused by such structural connection will be considered in creating the conditions for the equilibrium among the forces acting on the mirror 411.

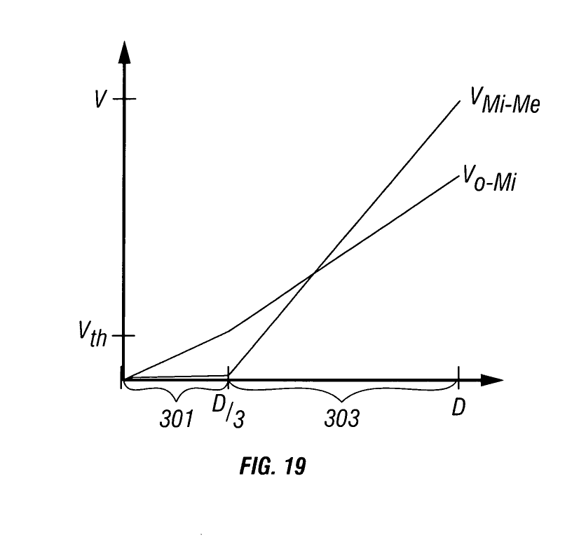

FIG. 19 illustrates exemplary voltage differences applied among the three electrodes (mirror 411, mechanical layer 407 and optical layer 403) to create a highly tunable MEMS device. In first segment 301, the voltages of the mechanical layer 407 and the mirror 411 are maintained at the same level, and the voltage difference (V_{O-Mi}) between the mirror 411 and the optical layer 403 can be changed between zero and the threshold voltage (Vₜₕ). As the voltage difference (V_{O-Mi}) changes, the mirror 411 may move or stay within the first segment 301 (0≦x≦D/3), for example, along the line 304 of FIG. 17. In the second segment 303, different voltages are applied to the mirror 411 and the mechanical layer 407, and the voltage difference (V_{Mi-Me}) between the mirror 411 and the mechanical layer 407 may further change to create equilibrium among the forces applied to the mirror 411. Accordingly, the mirror 411 may move or stay within the second segment 303 (D/3≦x≦D), for example, along the line 307 of FIG. 17. Actual voltage differences (V_{Mi-Me}) and (V_{O-Mi}) to create the balance among the forces may differ from those illustrated in FIG. 19, depending upon other factors, including the strength of the mechanical restoring forces of the mechanical layer 407 and/or the extension 418.

In another embodiment of the tunable MEMS device, the location of the mirror 411 may be tuned by creating equilibrium among the forces applied to the mirror while maintaining the voltage difference (V_{O-Mi}) between the optical layer 403 and the mirror 411 substantially constant when the mirror is moving within at least a portion of the second segment (D/3≦x≦D). In still another embodiment, the location of the mirror can be tuned while maintaining the voltage difference (V_{Mi-Me}) between the mirror 411 and the mechanical layer substantially constant when the mirror is moving within at least a portion of the second segment (D/3≦x≦D). One of ordinary skill in the art will appreciate that the equilibrium of the forces applied to the mirror 411 can be accomplished by controlling the voltage differences (V_{Mi-Me}) and (V_{O-Mi}) in a number of different ways.

In one embodiment, the tunable MEMS device provides an analog device that is tunable substantially throughout a range of linear or non-linear movement of the mirror 411 within an interferometric cavity. In one embodiment, the analog MEMS device may be used as a reflective display element tunable to any colored visible light or tunable to any wavelength of light.

In further embodiments, various parameters of the MEMS devices may be changed, which affect the size of the above-described forces to create a desired relationship between the movement of the mirror 411 and the potential difference(s) applied to electrodes of a MEMS device. The parameters affecting the size of the restoration force include the properties of the material used for the mechanical layer 407 and its geometrical configuration. The parameters affecting the size of the electrostatic forces are an effective overlapping area of two opposing electrodes (A), dielectric permittivity (ε), and a distance between two electrodes (d or d′) in Equations (1-4). One of ordinary skill in the art will appreciate and develop combinations of varying parameters to form a desired relationship between the movement of the mirror 411 and the voltages applied to the three electrodes of MEMS device 400, which are the optical layer 403, the mechanical layer 407 and the mirror 411.

These embodiments allow MEMS devices to be operated as an analog device over full range of the movement of the mirror. These tunable analog MEMS devices may be used to select any wavelengths of light by its interferometric modulation from the light incident to the MEMS device. Further detail on the analog MEMS device may be found in U.S. patent application Ser. No. 11/144,546, which is incorporated herein in its entirety by reference.

The foregoing description details certain embodiments of the invention. It will be appreciated, however, that no matter how detailed the foregoing appears in text, the invention can be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

What is claimed is:

1. A color display, comprising:
a fixed color display element configured to provide light of a first color; and
a variable color display element configured to provide light of a variable second color;
wherein the second color is variably controlled such that the variable color and fixed color display elements collectively and operatively display light of a perceivable color.

2. The display of claim 1, wherein each display element forms a subpixel.

3. The display of claim 1, wherein each display element forms an interferometric modulator.

4. The display of claim 2, wherein the second color is variably controlled such that the perceivable color falls on a line connecting the first and second color on a two-dimensional CIE chromaticity diagram.

5. The display of claim 3, wherein the fixed color is red.

6. The display of claim 5, wherein the fixed color display element further comprises an additional filter, the filter being configured to adjust the saturation of the red.

7. The display of claim 2, wherein each display element is further divided into a plurality of portions, each portion being controlled independently to either provide light or no light.

8. The display of claim 7, wherein a first and second number of portions are controlled to provide light within the variable and fixed color display elements respectively such that the variable color and fixed color display elements collectively and operatively display light of the perceivable color.

9. The display of claim 2, wherein the variable and fixed color display elements are controlled to provide light for a first period and a second period respectively such that the variable color and fixed color display elements collectively and operatively display light of the perceivable color.

10. The display of claim 1, further comprising:
a processor that is configured to communicate with said display elements, said processor being configured to process image data; and
a memory device that is configured to communicate with said processor.

11. The display of claim 10, further comprising a driver circuit configured to send at least one signal to the display elements.

12. The display of claim 11, further comprising a controller configured to send at least a portion of the image data to the driver circuit.

13. The display of claim 10, further comprising an image source module configured to send said image data to said processor.

14. The display of claim 13, wherein the image source module comprises at least one of a receiver, transceiver, and transmitter.

15. The display of claim 10, further comprising an input device configured to receive input data and to communicate said input data to said processor.

16. The display of claim 1, wherein the second color is variably controlled such that the variable color and fixed color display elements collectively and operatively display light of a perceivable color and brightness.

17. A color display, comprising:
a first variable color display element configured to provide light of a variable first color; and
a second variable color display element configured to provide light of a variable second color;
wherein the first and second colors are variably controlled such that the first and second variable color display elements collectively and operatively display light of a perceivable color.

18. The display of claim 17, wherein each display element forms a subpixel.

19. The display of claim 17, wherein each display element forms an interferometric modulator.

20. The display of claim 17, wherein the first color and the second color are variably controlled such that the perceivable color falls on a line connecting the first and second color on a two-dimensional CIE chromaticity diagram.

21. The display of claim 20, wherein the first color and the second color are variably controlled such that the perceivable color is at a substantially same distance from the first color as from the second color on a two-dimensional CIE chromaticity diagram.

22. The display of claim 18, wherein each display element is further divided into a plurality of portions, each portion being controlled independently to either provide light or no light.

23. The display of claim 22, wherein a first and second number of portions are controlled to provide light within the first and second variable color display elements respectively such that the first and second variable color display elements collectively and operatively display light of the perceivable color.

24. The display of claim 18, wherein the first and second variable color display elements are controlled to provide light for a first period and a second period respectively such that the first and second variable color display elements collectively and operatively display light of the perceivable color.

25. The display of claim 17, wherein the first and second colors are variably controlled such that the first and second variable color display elements collectively and operatively display light of a perceivable color and brightness.

26. A color display, comprising:
a variable color display element configured to provide light of a variable color,
wherein the variable color display element is controlled to provide light of a first color for a first period and then light of a second color for a second period such that the display element provides light of a perceivable color.

27. The display of claim 26, wherein the variable color display element forms a subpixel.

28. The display of claim 26, wherein the variable color display element forms an interferometric modulator.

29. The display of claim 26, wherein the first color and the second color are variably controlled such that the perceivable color falls on a line connecting the first and second color on a two-dimensional CIE chromaticity diagram.

30. The display of claim 29, wherein the first color and the second color are variably controlled such that the perceivable color is at a substantially same distance from the first color as from the second color on a two-dimensional CIE chromaticity diagram.

31. The display of claim 27, wherein the display element is further divided into a plurality of portions, each portion being controlled independently to either provide light or no light.

32. The display of claim 31, wherein a first and second number of portions of the display element are controlled to provide light for the first and second periods respectively such that the display element provides light of the perceivable color.

33. The display of claim 26, wherein the variable color display element is controlled to provide light of a first color for a first period and then light of a second color for a second period such that the display element provides light of a perceivable color and brightness.

34. The display of claim 26, wherein the variable color display element is controlled to provide light of a first color for a first period and then light of a second color for a second period and then to be black for a third period such that the display element provides light of a perceivable color and brightness.

35. A color display, comprising:
a plurality of pixels, each pixel comprising two or fewer subpixels, wherein each pixel is capable of displaying a group of colors comprising a substantially red color, a substantially green color, and a substantially blue color.

36. The display of claim 35, wherein each pixel comprises at least one subpixel configured to provide light of a variable color.

37. The display of claim 35, wherein each subpixel forms an interferometric modulator.

38. A method of displaying a perceivable color, the method comprising:
providing a display comprising a fixed color display element configured to provide light of a first color and a variable color display element configured to provide light of a variable color; and
controlling the variable color display element to provide light of a selected second color such that the first color and second color collectively provide light of the perceivable color.

39. The method of claim 38, further comprising:
controlling the fixed color display element to provide light for a first period; and
controlling the variable color display element to provide light for a second period.

40. The method of claim 38, wherein each display element is further divided into a plurality of portions, each portion being controlled independently to either provide light or no light, further comprising:
controlling a first number of portions within the fixed color display element to provide light; and
controlling a second number of portions within the variable color display element to provide light.

41. The method of claim 38, wherein the second color is selected such that the perceivable color falls on a line connecting the first and second color on a two-dimensional CIE chromaticity diagram.

42. The method of claim 38, wherein the first color and second color collectively provide light of the perceivable color and brightness.

43. A method of displaying a perceivable color, the method comprising:
providing a display comprising a first and second variable color display element, each element being configured to provide light of a variable color; and
controlling the first and second variable color display element to provide light of a selected first and second color respectively such that the first color and second color collectively provide light of the perceivable color.

44. The method of claim 43, further comprising:
controlling the first element to provide light for a first period; and
controlling the second element to provide light for a second period.

45. The method of claim 43, wherein each display element is further divided into a plurality of portions, each portion being controlled independently to either provide light or no light, further comprising:
controlling a first number of portions within the first element to provide light; and
controlling a second number of portions within the second element to provide light.

46. The method of claim 43, wherein the first and second color are selected such that the perceivable color falls on a line connecting the first and second color on a two-dimensional CIE chromaticity diagram.

47. The method of claim 43, wherein the first color and second color collectively provide light of the perceivable color and brightness.

48. A method of displaying a perceivable color, the method comprising:
providing a display comprising a variable color display element configured to provide light of a variable color; and
controlling the variable color display element to provide light of a selected first color for a first period and provide light of a selected second color for a second period such that the display element provides light of a perceivable color.

49. The method of claim 48, wherein the display element is further divided into a plurality of portions, each portion being controlled independently to either provide light or no light, further comprising controlling the display element such that a first and a second number or portions within the display element provide light during the first and second period respectively.

50. The method of claim 48, wherein the perceivable color falls on a line connecting the first and second color on a two-dimensional CIE chromaticity diagram.

51. The method of claim 48, wherein the display element provides light of a perceivable color and brightness.

52. A color display, comprising:
means for providing light of a first color; and
means for providing light of a variable second color;
wherein the second color is variably controlled such that the means for providing light of a first color and the means for providing light of a second color collectively and operatively display light of a perceivable color.

53. The display of claim 52, wherein the means for providing light of a first color comprises an interferometric modulator configured to display a fixed color.

54. The display of claim 52, wherein the means for providing light of a variable second color comprises an interferometric modulator configured to display a variable color.

55. The display of claim 52, wherein the means for providing light of a first color and the means for providing light of a second color collectively and operatively display light of a perceivable color and brightness.

56. A color display, comprising:
means for providing light of a variable first color, and
means for providing light of a variable second color,
wherein the first and second colors are variably controlled such that the means for providing light of a variable first color and the means for providing light of a variable second color collectively and operatively display light of a perceivable color.

57. The display of claim 56, wherein each means for providing light of a variable color comprises an interferometric modulator configured to display a variable color.

58. The display of claim 56, wherein the first and second colors are variably controlled such that the means for providing light of a variable first color and the means for providing light of a variable second color collectively and operatively display light of a perceivable color and brightness.

59. A color display, comprising:
means for providing light of a variable color; and
means for processing image data, the means being configured to communicate with the means for providing;
wherein the means for providing is controlled to provide light of a first color for a first period and then light of a second color for a second period such that the means for providing provides light of a perceivable color.

60. The display of claim 59, wherein the means for providing light of a variable color comprises an interferometric modulator configured to display a variable color.

61. The display of claim 59, wherein the means for providing is controlled to provide light of a first color for a first period and then light of a second color for a second period such that the means for providing provides light of a perceivable color and brightness.
